(19) United States
(12) Patent Application Publication
(10) Pub. No.: US 2009/0060316 A1
(43) Pub. Date: Mar. 5, 2009

(54) Method for Monitoring a Rapidly-Moving Paper Web and Corresponding System

(76) Inventor: Hannu Ruuska, Muurame (FI)

Correspondence Address: FILDES & OUTLAND, P.C., 20916 MACK AVENUE, SUITE 2, GROSSE POINTE WOODS, MI, 48236, US

(21) Appl. No.: 12/224,162

(22) PCT Filed: Feb. 22, 2007
(86) PCT No.: PCT/FI2007/050096

§ 371 Date: Aug. 19, 2008

Related U.S. Application Data
(60) Provisional application No. 60/789,572, filed on Apr. 6, 2006.

(30) Foreign Application Priority Data
Feb. 22, 2006 (FI) 20065129
Sep. 19, 2006 (FI) 20065569

(51) Int. Cl. G06K 9/00

(52) U.S. Cl. 382/141

(57) ABSTRACT

The invention relates to a method for monitoring a rapidly-moving paper web. In the method, images of the rapidly-moving web are taken with cameras at several consecutive positions, of the same cross-direction point of the web. The images are analysed in real time in order to detect deviations, and the position data of the deviations are determined. Each deviation found in the analysis is connected to an event chain in real time using a selected criterion on the basis of the position data of each deviation. Images containing a deviation are shown to the operator immediately as event chains.

The present invention relates to a method for monitoring a rapidly-moving paper web, in which method images of the rapidly-moving web are taken with cameras in several consecutive positions, of the same cross-direction point of the web, and the images are analysed in order to detect deviations, and the position data of the deviations are determined, and each deviation found in the analysis is connected to the event chain using a selected criterion on the basis of the position data of each deviation, and the images containing the deviation are displayed to the operator. The invention also relates to a corresponding system.

In the prior art, many systems are known, in which webs are monitored. In these systems, the monitoring of the web takes place with a considerable delay. For example, Finnish patent publication FI 115670 discloses a method and system for monitoring a paper web and/or wire running through the double-wire section of a paper machine. The web being monitored is first imaged and the images then analysed in several stages. In the first stage, potential defect images are sought for more detailed analysis. Potential defect images are sought by comparing an image recorded from the monitoring situation with one recorded from an ideal situation. Potential defect images can also be sought by comparing the changes between consecutive images, or by comparing the grey-tones of a monitored image with given boundary values. In addition, the search for potential defect images can be based on pattern recognition. If deviations from the normal state are detected in the analysis, the deviating images are recorded digitally on a hard disk for later analysis. In the systems appearing in the prior art, the analysis of the images taken of the web is slow. In the analysis according to the prior art described above, the machine operator performs the second stage. Thus the second stage of the analysis is really slow.

In more advanced systems, on the basis of the information obtained from the defect-detection system, feedback synchronization can be used to collect information for processing by the machine operator. The collection from a film bank of data used in feedback-linked synchronization is disclosed in patent FI 112549. The information collected from the film bank must still be processed manually by the machine operator. To achieve backwards synchronization with an accuracy of 5 seconds, these 5 seconds must be recorded from the film bank as a defect tape, which the machine operator examines manually. When examining the collected material, the machine operator can view about 10 images per second. As one second contains 50 images, it will take 25 seconds to check through the 250 images contained in 5 seconds. If we assume that a defect is found on average about half the time, searching will take 12 seconds per camera. If there are 15 cameras on the machine, which is a low number, it will take the operator 3 minutes to examine a single defect. It takes about 30 minutes to make a reel at the reeling drum, in which there are typically several defects, for example 15 defects. If there are 15 defects in a reel, it will take 45 minutes to manually process a reel for defects. This means that the manual browsing of defect tapes is extremely time-consuming and laborious, so that in many cases it is not even done. Because in this system examining starts from a defect detected at the reeler, the examination takes place after the event and can only provide information on what has happened on the machine. The prior art cannot be used to monitor processes in real time. Though it would be necessary to find smaller deviations, the need for manual work increases using systems according to the prior art to become unreasonably great, even when searching for defects larger than those already referred to.

A web-break monitoring system (Web Monitoring System=WMS) known in the prior art images the process on the paper machine, from the wire to the operation of the unit preceding reeling. Thus the scope of the web-break monitoring system covers both the press and drying sections, as well as possible calendering or coating stations. The web monitoring system notifies of web breaks that it detects. In connection with the reeler, the finished web is examined by a defect-detection system (Web Inspection System=WIS). As is known, the web-break monitoring and the defect-detection systems are separate and different technologies are used in them. At most, they are combined using synchronization after the event.

A feature common to systems according to the prior art is that PCs are used in the initial calculation in examining the image stream coming from the cameras. The final analysis is performed by the machine operator. In addition, the components of the systems are connected to each other using copper conductors, so that data transfer is slow. All in all, the operating and construction costs of systems according to the prior art are high.

The invention is intended to create a new type of method for monitoring a rapidly-moving paper web. In the method the paper web is observed in real time. The characteristics features of the method according to the present invention are stated in the accompanying Claim 1. The invention also relates to a corresponding system, by means of which defects in a rapidly-moving web can be detected more accuracy than previously. The characteristic features of the system according to the present invention are stated in the accompanying Claim 9. In the solution according to the invention, the analysis of the images takes place entirely mechanically and in real time, an event chain between the deviations found from the images is created mechanically in real time.

The detection of deviations in paper webs is very important, as deviations in webs indicate problems. The term paper web refers to paper, board, pulp, tissue paper, and coated or otherwise finished papers. Correspondingly, the term paper machine refers to paper machines, board machines, pulp machines, and tissue-paper machines, as well as to coating machines. In the method for monitoring a rapidly-moving paper web, images of the rapidly-moving paper web are taken at several consecutive positions at the same location in the width direction of the web. In other words, the same width-direction location on the web is imaged at several consecutive positions. The images taken of the web at consecutive positions are analysed to find deviations and the position data of the deviations are thus determined automatically and entirely mechanically.

A deviation detected in a paper web can be a defect or a break. Though a defect and a break appear to be different, they are typically caused by the same factors. Selected criteria are used to link each deviation found in the analysis to the event chain on the basis of the position data of each deviation. The images containing the deviation are displayed to the machine operator. In addition, the images taken at each position are analysed by image analysis entirely mechanically and in real time, in order to distinguish deviations and to determine their position data. An event chain is created between the images distinguished at different positions by combining them in real time and mechanically using selected criteria as belonging the same event chain, and the event chain is displayed to the operator automatically using the selected criteria. In addition, the images taken at each position are analysed by image analysis entirely mechanically and in real time, in order to distinguish deviations and to determine their position data. As the analysis is performed in real time, the images can be analysed immediately and need not be stored for even a moment. As the analysis takes place mechanically, the operator need not perform the actual analysis, but instead can monitor the results of the analysis. Thus, the deviations are found and their position data are determined, in real time. The event chain is displayed to the operator automatically using the selected criteria.

The creation of an event chain based entirely on a mechanical image analysis, performed at least at the imaging frequency, avoids the storage of images. In addition, the mechanically performed image analysis permits the operator to concentrate of monitoring the results of the image analysis and not on the analysis of the images. The essential feature is that an analysis performed mechanically at least at the imaging frequency permits the creation of an event chain utilizing predictive synchronization. In predictive synchronization, an event chain is created between deviations, while the deviation is still in the paper machine. In predictive synchronization, the defined position information of each deviation in one position is compared in real time with the position information of the detected deviation in a second position. When each deviation found in the analysis is shown to the operator automatically in an event chain, the operator can concentrate on monitoring the automatically created event chain. As the operator receives data on the deviation automatically as an event chain, the operator can closely monitor the cause-consequence relations prevailing in the process.

In other words, an event chain is created between the detected deviations, by utilizing predictive synchronization, in which the images are synchronized to form an event chain already when the deviation is still in the machine. The event chain in question is displayed to the operator in real time. The utilization of predictive synchronization creates an event chain automatically on the basis of image-analysis mathematics. In predictive synchronization, deviations detected at one position are compared with deviations detected at a second position. If the deviation in not sufficiently close in time to the calculated value, it is a different deviation. In that case, its own event chain is started for it. In other words, in predictive synchronization each deviation is classified as belonging to an event chain. If deviations are found elsewhere than in the calculated positions, they are different deviations. An event chain is triggered by any deviation whatever detected in an image taken with a camera. When examining the images, the deviation triggering an event chain can be a deviation from background noise, or a specially set condition. The position data of a detected deviation is compared with the real position data of other detected deviations. Using the set criteria, the deviation is calculated to be part of an event chain already started. The condition can be, for example, that a deviation appearing later is sufficiently precisely at the same point in the width and at an accuracy of ±2 at the same point in time as the preceding/original deviation. The selected criterion can also be based on the shapes of the deviations. In addition to the position information, the shapes of the deviations can be used to connect the deviations. If the deviations are proven to be due to the same defect, they are displayed to the operator in the same event chain and thus as the same defect. The event chain is displayed using a selected condition. If there are few deviations, all the deviations can be displayed. If they are many, they are prioritized and the most important according to the selected criterion are displayed. The selected criterion can be, for example, that the largest defects will be displayed.

A deviation detected in the first position, which could be, for example, edge fraying at the pick-up of the paper machine, opens an event chain. Images taken of the deviation caused by the defect, taken by the other cameras in the event sequence, are then added to the defect chain. The event is monitored until it has been reeled, or causes a web break.

By analysing the images mechanically and displaying the deviations found in the analysis automatically as an event chain to the operator, the process becomes entirely real-time in connection with even large data flows. When using the method according to the invention, the operator need not participate in any way in the analysis of the images, but instead receives the results of the analysis directly in real time as a basis for decision making. In addition, no stage in the analysis of the images takes place by human eye. Analysis by human eye is always slow, so that by making the analysis entirely mechanical the analysis of the images is accelerated considerably. Even if each operator were to analyse images taken of the web as well as they are able, there would be considerable differences between operators. Thus analyses performed by operators are always subjective to some extent. In addition, the elimination of manual work permits the monitoring of much smaller deviations than those that can be monitored in the prior art. According to the invention, it is possible to monitor all significant deviations in real time. By analysing more deviations than previously, many of which are smaller than those that can be analysed in the prior art, information on dangerous and non-dangerous events will be increased considerably.

The method according to the invention in turn permits image analysis to be performed from uncompressed images. In addition, the analysis results can be displayed to the operator in an uncompressed form. Image analysis from uncompressed images is possible because the analysis is performed immediately after the images are taken. If the image analysis were to be performed later, the images would need to be stored prior to the performance of the image analysis. As each camera produces an image stream in the order of up to 1 Gb/s, the storage capacity by itself will cost a considerable amount. The use of image analyses performed from uncompressed images will achieve better analysis results than previously, as when using highly-developed image-analysis methods much essential information is lost when the images are compressed. Predictive synchronization permits the images to be displayed immediately to the operator in an uncompressed form. The immediate image analysis and the predictive synchronization of the images thus permit smaller storage capacities relative to the image stream than the prior art. In addition, when displaying the analysis results as uncompressed images, the operator will see the deviations precisely from the images. The implementation of such a system requires an entirely new type of technology.

In one embodiment, at least 50 images/s are taken of the paper web. Thus a rapidly-moving web can be imaged continuously using even a short imaging interval.

In a second embodiment, the level of the images taken is at least black-and-white VGA with a depth of 10 bits. The images in question have sufficient quality for mechanical analysis to be performed on them with a satisfactory accuracy.

In a third embodiment, the images consist of pixels, which at the greatest precision correspond at a maximum to a 10*10 mm area, preferably to a maximum of a 5*5 mm area. This precision permits the process to be monitored with sufficient accuracy to find all important defects.

By analysing the images mechanically and displaying the deviations found in the analysis to the operator automatically as an even chain, the process is made fully real-time, even in connection with large data flows. Such large data flows occur when monitoring a rapidly-moving web, when at least 50 images/second are taken. Thus the paper web is imaged continuously, if the imaging distance is sufficiently great. When imaging a web that is moving at a speed of 2400 m/min, over a distance of 800 mm, 50 images/s in the direction of movement of the paper web will be sufficient for the web to be imaged in its entirety. In addition, the web is imaged precisely that the most precise imaging of the process by the process-monitoring cameras corresponds to a maximum of an area 10*10 mm, preferably an area 5*5 mm. The quality of the images is at least black-and-white VCA, according to the PAL or NTSC standards. A typical VGA resolution is 640*480. At such an imaging frequency, precision, and image quality, the data flow becomes a considerable size. The data flow in question is analysed using highly-developed image-analysis methods, i.e. the detection of deviations is based on image analysis and probability calculation. In other words, a defect in the web causes a deviation signal, which is detected by using highly-developed image-analysis methods, combined with probability calculation. The creation of an event chain utilizing predictive synchronization takes place automatically on the basis of image-analysis mathematics. The highly-developed image analysis preferably includes pattern recognition, which is immediate. Thus the shape of the pattern relating to the deviation and its position are detected. The importance of pattern recognition is particularly great in terms of the creation of the event chain. Only similar deviations are combined to the same event chain. When a line is detected in an earlier position and a point in a position after it are close to each other according to the position data, they are not associated with each other, due to the difference in pattern. On the other hand, even very different patterns can be associated with each other. Such a situation occurs, for example, when the position data shows a small hole in an earlier position and a large hole in a later position as being close to each other. By exploiting pattern recognition when creating the event chain, the patterns of the deviations being linked should be similar, or else it should be possible for the later pattern to develop its shape from the first pattern. Pattern recognition should include pattern classification, by means of which the detected deviations are classified in terms of default values. In the image-analysis methods that are utilized, 0.05-10 teraflops, preferably 0.25-5 teraflops, at a calculation power of 600 Mb/s per image stream, are used.

Highly-developed image-analysis methods are described in the literature, for example: Image Processing: Analysis and Machine Vision—Milan Sonka (1999). Slightly more advanced methods are given in the book: Computer Vision: A Modern Approach—David A. Forsyth, Jean Ponce (2003). ISBN-10: 0130851981. Pattern recognition is presented, for example, in the literature in the following list: Sergios Theodoridis, Konstantinos Koutroumbas, (2006), Pattern Recognition (3^{rd} edition), Elsevier. ISBN 0-12-369531-7.
Phiroz Bhagat, (2005) Pattern Recognition in Industry, Elsevier, ISBN 0-08-044538-3.
Richard O. Duda, Peter E. Hart, David G. Stork, (2001) Pattern Classification (2^{nd} edition), Wiley, New York. ISBN 0-471-05669-3.
Dietrich Paulus and Joachim Hornegger, (1998) Applied Pattern Recognition (2^{nd} edition), Vieweg. ISBN 3-528-15558-2.
J. Schuermann, (1996) Pattern Classification: A Unified View of Statistical and Neural Approaches, Wiley & Sons. ISBN 0-471-13534-8.
Sholom Weiss and Casimir Kulikowski, (1991) Computer Systems that Learn, Morgan Kaufmann. ISBN 1-55860-065-5.

The detection of deviations from a paper web is very important, as deviations tell of problems. Here, the term paper web also refers to board, pulp, tissue-paper, and coated or otherwise finished papers. A deviation detected in a paper web can be a defect or a break. Of course a defect can be insignificantly small, which the operator decides from experience and expertise. Even small defects can, however, indicate a future problem. Though a defect and a break appear in different ways, they are typically caused by the same factors.

The first defect detected, which can be, for example, edge fraying at the pick-up of a paper machine, opens an event display. Images taken of the deviation caused by the defect by other cameras are then added to the defect chain in the order of the event. The event is monitored, until it is reeled or caused a web break.

In a second embodiment, 0.05-10 teraflops, preferably 0.25-5 teraflops, are used in the analysis of the images, the calculation power per camera, calculated on the image stream, being 600 Mb/s. When the camera's precision, dynamics, and imaging speed change, the data, i.e. image stream coming from the camera also changes. The calculating power required per camera will then also change.

In the following, the invention is examined in detail with reference to the accompanying drawings showing some applications of the invention, in which

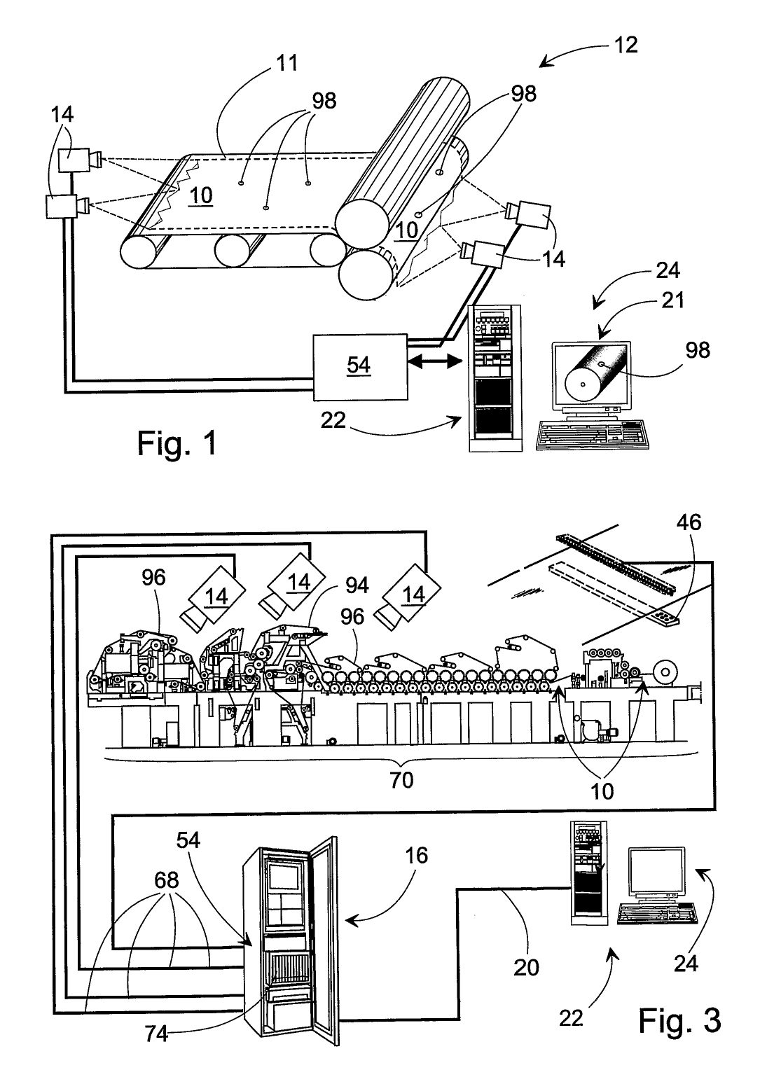

FIG. 1 shows an apparatus, in which the method according to the invention is used to detect deviations in a rapidly-moving web,

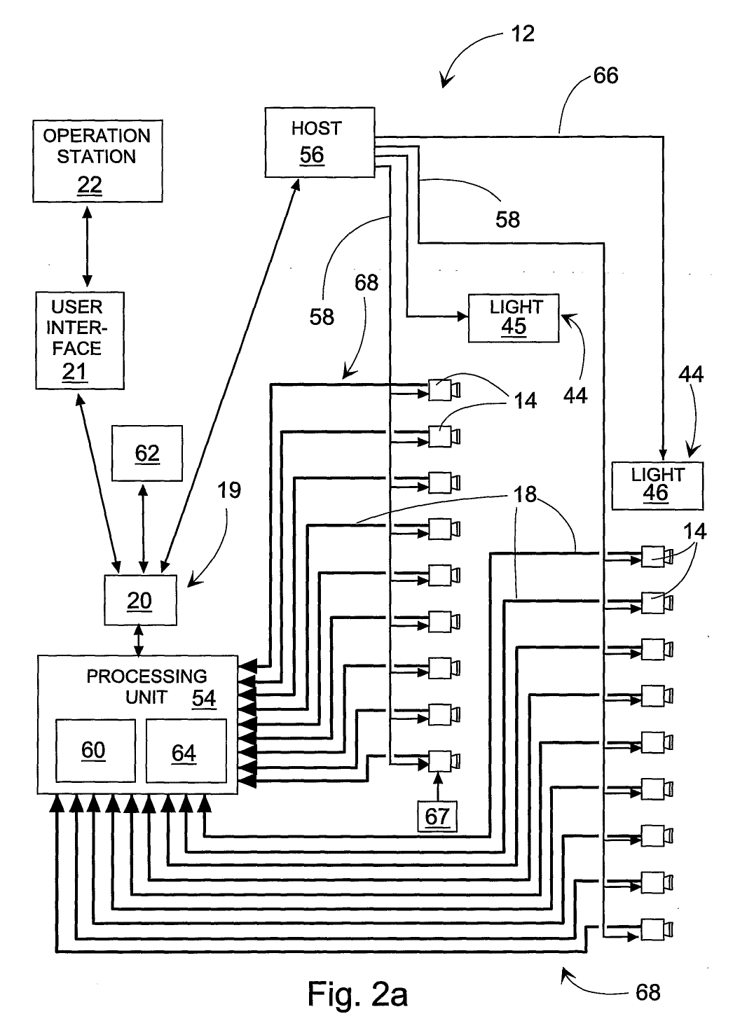

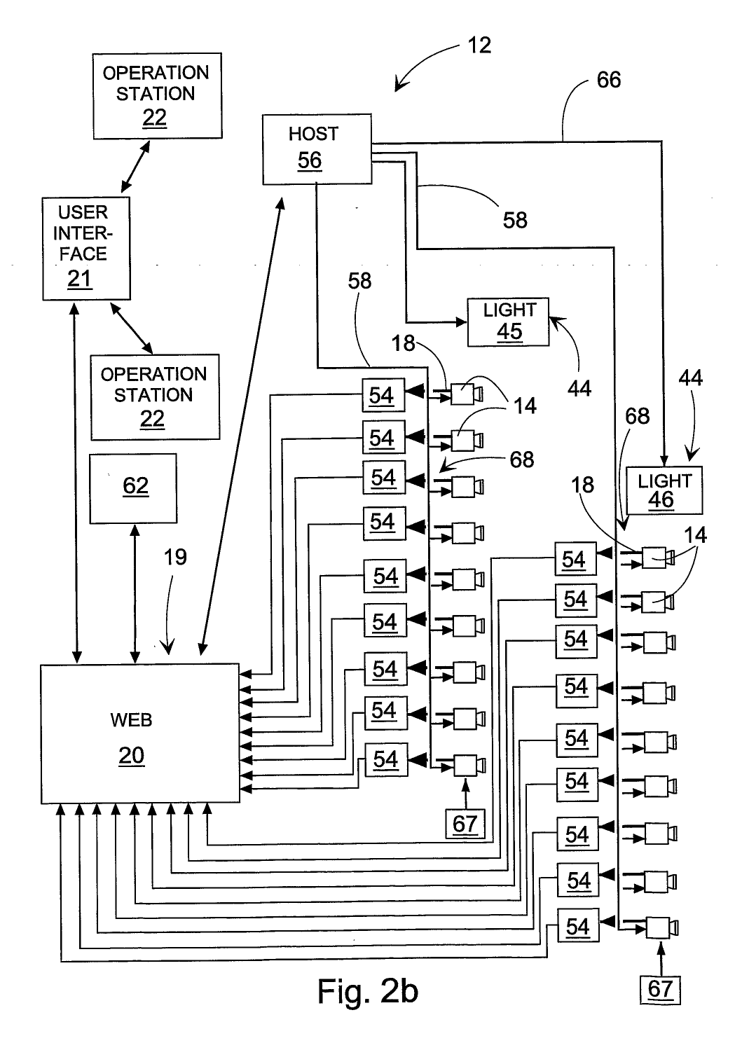

FIG. 2a shows a diagram of an implementation of the system according to the invention, using one processor unit for several cameras,

FIG. 2b shows a diagram of an implementation of the system according to the invention, using one processor unit for one camera,

FIG. 3 shows an apparatus, in which the method according to the invention is used in detecting deviations on a web,

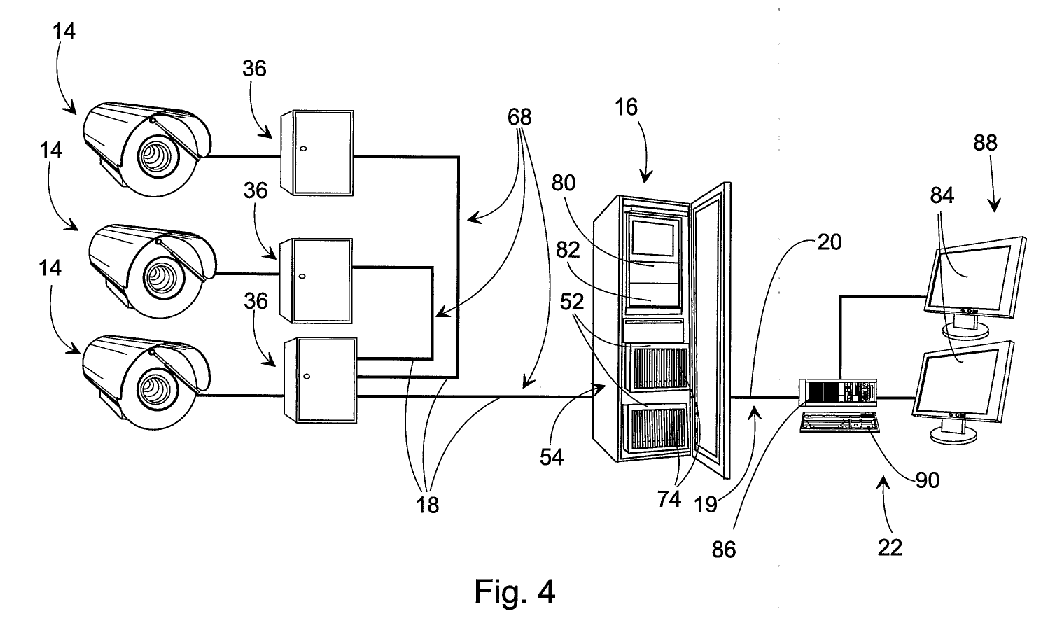

FIG. 4 shows the construction of the system according to the invention, from the cameras to the operation station,

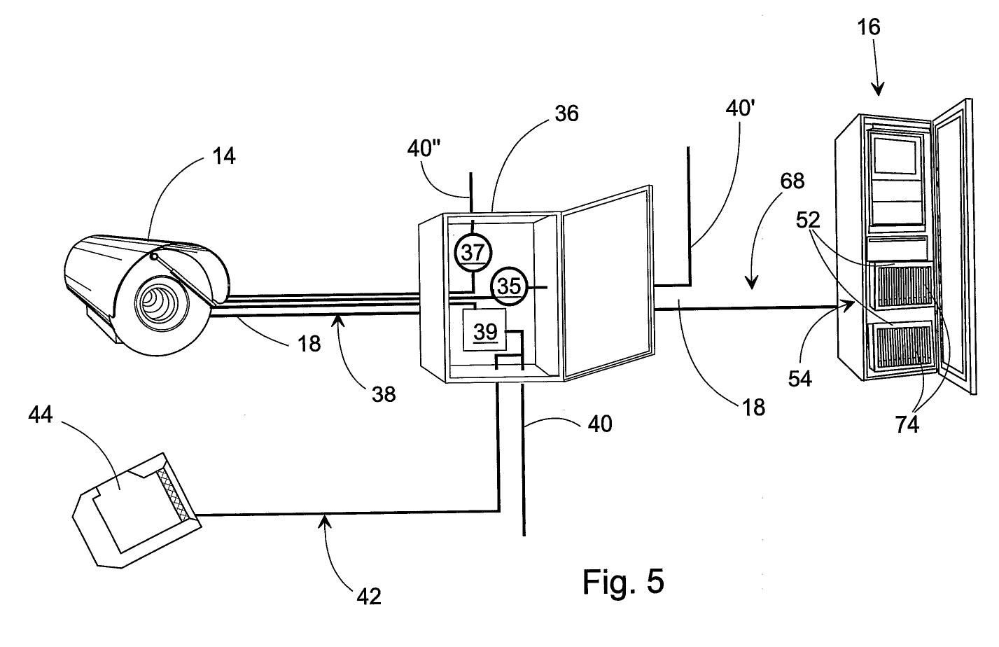

FIG. 5 shows the construction of the system according to the invention, from the system cabinet to the camera and the lighting element,

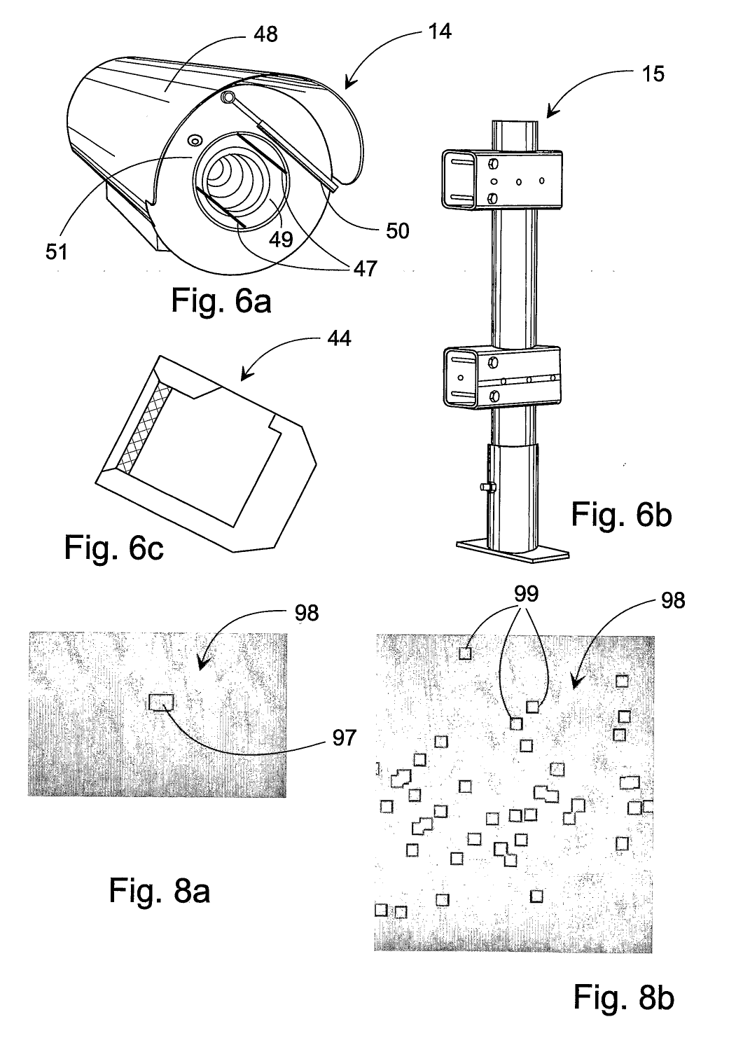

FIG. 6a shows a camera used in the system according to the invention,

FIG. 6b shows the mounting frame of the camera used in the system according to the invention,

FIG. 6c shows the lighting element used in the system according to the invention,

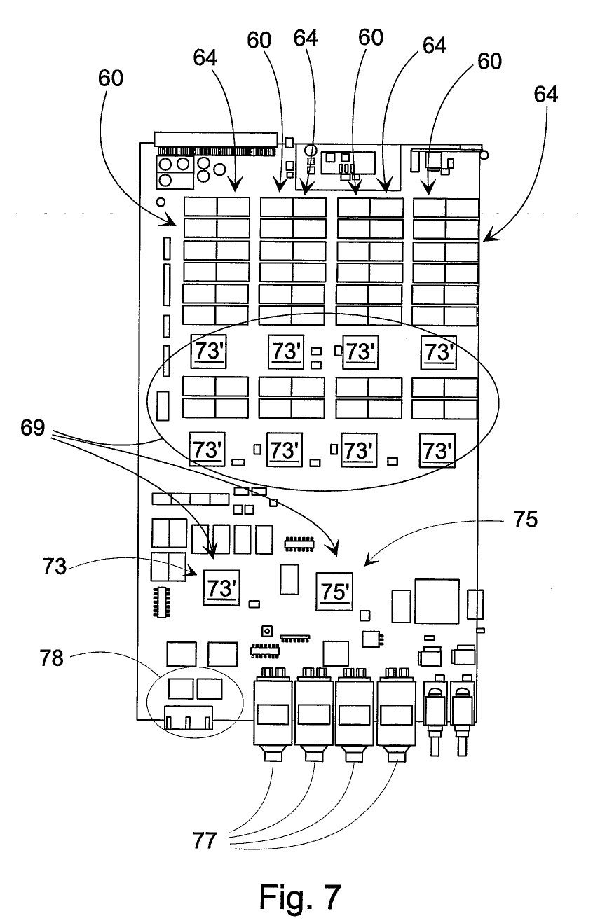

FIG. 7 shows the image-analysis processor card used in the system according to the invention,

FIG. 8a shows a defect detected by the system according to the invention, which is similar to defects detectable by the human eye,

FIG. 8b shows defects detected by the system according to the invention, which are similar to defects detectable by the human eye,

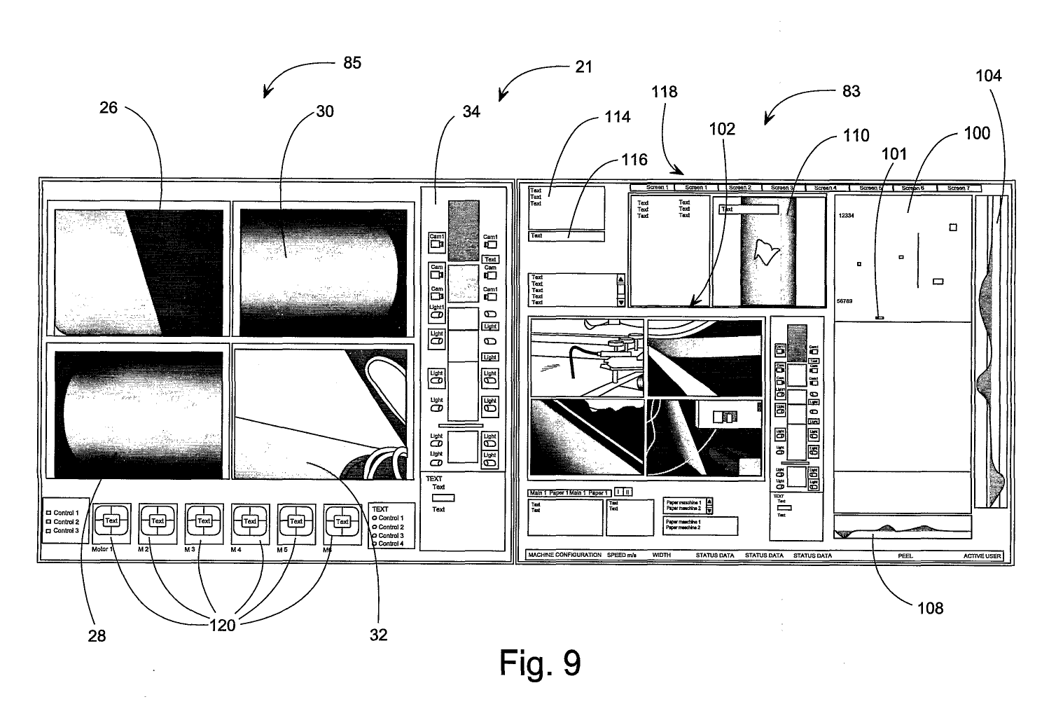

FIG. 9 shows a view of the user interface of the system according to the invention,

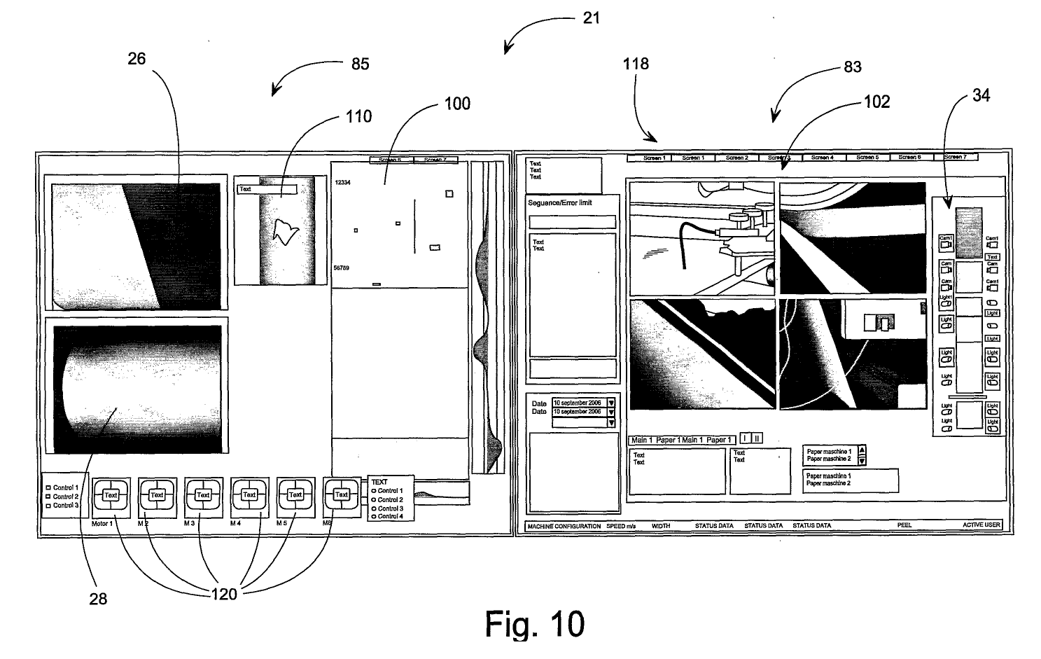

FIG. 10 shows a view of the user interface of the system according to the invention, and

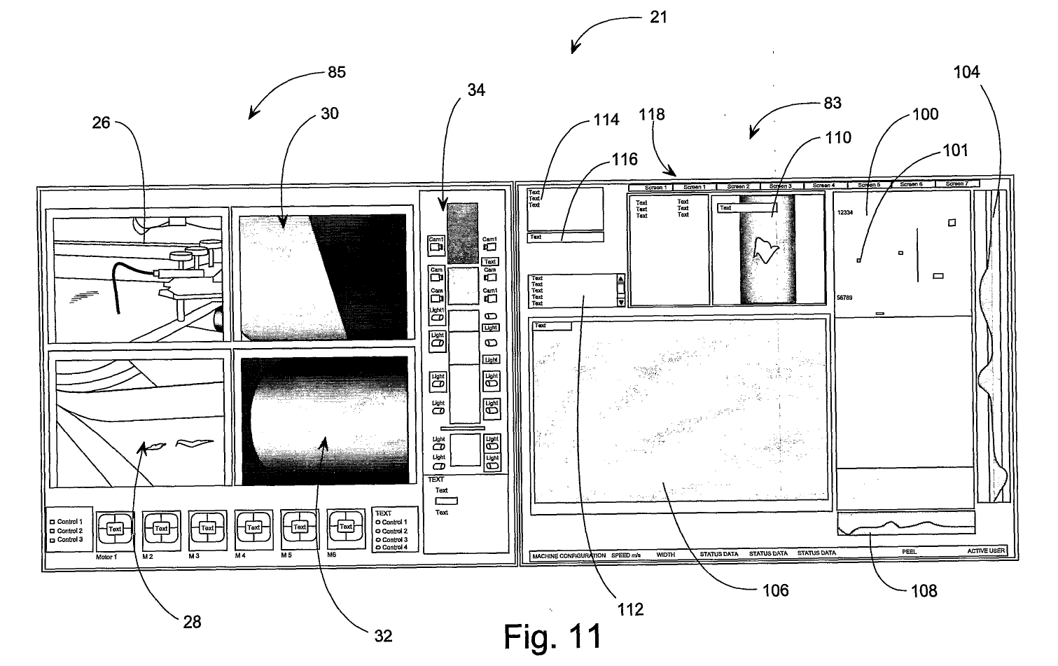

FIG. 11 shows a view of the user interface of the system according to the invention.

FIG. 1 shows a system 12 for monitoring a rapidly-moving paper web 10. The system 12 includes cameras 14, a processing unit 54, an operation station 22 and host unit 56, and display means 24. Using the cameras 14, images are taken of the web 10 at several consecutive positions at the same point in the width-direction of the paper web 10. The processing unit 54 is used to search and analyse the images taken of the paper web 10. The operation station 22 is used to control the system, while the host unit 56 is used to time the imaging. The display means 24 are used to display the images to the operator. In addition, the images taken at each position are arranged to be analysed in the processing unit 54 entirely mechanically and in real time by the image-analysis method, in order to distinguish each image containing a deviation 98 and to determine the position information of the deviation 98. The image analysis preferably includes pattern recognition, in order to recognise the pattern of the deviation. The images taken at different positions are arranged to be combined into the same event chain, using selected criteria. The event chain is arranged to be displayed using the said display means 24 to the operator, using a selected criterion automatically.

In the system shown in FIG. 1, the method according to the invention is used in detecting deviation 98 in a rapidly-moving paper web 10. The rapidly-moving paper web 10 is supported on a fabric 11. The observation of deviations as an event chain permits better prediction than previously on a paper machine. The event chain based on predictive synchronization permits deviations to be detected earlier than before, so that further damage can be prevented. Such further damage is, for example, damage to the rolls of a matt calender. The further damage in question can be prevented, if a pulp lump, which could damage the rolls of the matt calender, is seen beforehand approaching the matt calender. In addition, as the analysis takes place mechanically and entirely automatically, the operator is notified of smaller deviations than previously. As the operator receives information on smaller deviations than previously, information on the state of the process is increased considerably.

The cameras 14 in the system shown in FIG. 1 are used to image the paper web 10. The images taken of the paper web are analysed using the processing unit 54, in order to find deviations. The analysis is performed entirely mechanically. Thus the operator does not analyse the images, but instead is shown directly the result of the analysis as an event chain. The image analysis is performed immediately after the images are taken, i.e. the process is real-time. Deviations found are registered and the operator is notified. The operator is notified of a deviation 98 in a user interface 21, which is used as the operation station 22. The analysis of the images is performed entirely mechanically. Thus the operator's time is not taken up with analysing images. In addition, by performing the analysis mechanically the process becomes real-time. As the mechanically performed process is real-time, images are analysed immediately after being taken. As the image analysis is performed in real time, the images are analysed at the same or a faster frequency than that at which they are taken. Thus the images are not stored anywhere before analysis, but instead analysis takes place advantageously immediately. If the paper web moves at 100 m/min and the distance being imaged is 400 mm long, 4.2 images of the web should be taken each second for the web to be imaged continuously. However, paper webs move typically at least at 800 m/min and the distance being imaged is typically at most 250 mm long. Thus, more than 50 images should be taken each second to image the web continuously. If the imaging frequency is lower, part of the web will not be imaged. In other words, images should be taken at such a frequency, that the entire web can be imaged. The web can then be analysed over its entire longitudinal direction. The significance of the immediate analysis of the images increases as the speed of the web being imaged increases. For example, on a paper machine with a web moving at 2100 m/min and the distance being imaged being 200 mm, already 175 images should be taken each second, in order to image the web continuously.

In the arrangement shown in FIG. 1, the images, in which deviations 98 are detected on the basis of the image analysis performed by the processing unit 54, are displayed immediately after the image analysis to the operator as an event chain by means of the user interface 21 used by the operation station 22. The immediate display of the analysis results as an event chain permits anticipatory control of the web-forming machine. Considerable savings can be achieved using a web-forming machine with anticipatory control. Savings are achieved on the paper machine when defects in the paper web are detected at the earliest possible stage and the process control is based on these detections. Without real-time monitoring based on predictive synchronization, the situation would become much worse. In addition, the paper machine brings savings, not only by avoiding damage, but also by making it easier to avoid web breaks. In order to prevent a web break, the coating unit can be switched off, for example, if the web is expected to break at the coating unit. Savings are achieved when there are no breaks in production. All that will happen is that a length of poorly coated paper web will have to be sent to broke.

Paper webs that move at a speed greater than 100 m/min are advantageously inspected using the method according to the invention, as it provides an opportunity to monitor the web when the imaging area is very short. In some applications, the imaging area can be only 10 mm long. If the speed of the paper web is 100 m/min and the width of the imaging area, i.e. its dimension in the direction of travel of the paper web is 10 mm, more than 160 images should be taken of the paper web each second, to image the web continuously. Even the longest imaging areas are only 400 mm long. Only in very rare situations is the web being imaged located in such a way that it can be imaged over a distance of more than 400 mm. If the visible distance of the web is longer, considerable instability typically appears in it, so that imaging is by no means always appropriate. When the web moves rapidly and the imaging distance is short, the imaging frequency should be very high, so that the entire web can be imaged continuously. The imaged distance of the web is preferably 20-200 mm. The imaged distance of the web is preferably more than 20 mm, because at the speeds of the web prevailing on a paper machine manufacturing a web the imaging frequency should be raised considerably in imaging taking place from an area of less than 20 mm. On the other hand, there are practically no observation positions on paper machines, at which the web could be imaged over a distance longer than 200 mm.

The speed of a paper web is typically more than 100 m/min, as stated above. The method can be applied without problems in faster processes too. One central area of application are paper machines with speeds of 400-2400 m/min. Within a few years they will reach 3500 m/min. The method can also be applied with considerably faster webs. Such webs can move at even 10 000 m/min while nevertheless being able to be monitored by means of the method according to the invention. When imaging webs moving at such a speed, the images can be analysed according to the method in a processing unit entirely mechanically immediately after they have been taken and deviations can be displayed to the operator as an event chain.

Predictive synchronization is used in combining the deviation images containing a deviation to form an event chain, so that event chains can be created in real time. When creating an event chain using predictive synchronization, the event chain is created between the images by calculating the assumed position data for the detected deviations from the first image, and comparing the position data of later detected deviations, using a selected criterion, with the assumed position data detected earlier. The predictive synchronization is used to check whether the deviations detected by the different cameras are due to the same defect in the web, before the defect point reaches the next observation position. Predictive synchronization is used to create an event chain in real time. The use of image analysis and predictive synchronization achieves fully automatic detection of deviations and the presentation of deviations as defect families, without time-consuming manual work. By using predictive synchronization, defects are classified into the same event chain, i.e. as belonging to the same defect family, already when they are on the paper machine. In its entirety, the system can be using to considerably reduce loss of production, as breaks and machine damage can be avoided. Presenting the event chain in real time means that in practice they is no noticeable delay in the detection intervals of the process. Analysis thus takes place in the time that the defect takes to progress between two cameras imaging the process. Thus the analysis from the preceding camera is ready before the point on the web reaches the following camera. Web breaks occurring on a paper machine can be avoided, as the operator can take measures to prevent web breaks, on the basis of the deviations detected in the image analysis and displayed as an event chain. The event chain helps the operator visualize the cause-effect relationships prevailing between the deviations appearing in the web. As a single system processes all types of deviations, such as defects and breaks, it is easier for the operator to monitor the cause-effect relationships.

The detection of defects is based on image analysis and probability calculation. A defect in the web causes a deviating signal, which is detected by highly-developed image-analysis methods combined with probability calculation. The term highly-developed image-analysis methods refers, for example, to convolution, DOG, and similar theories. In highly-developed image analysis, median filters are advantageously utilized. The image-analysis methods utilized in the invention are much more highly developed than those used in existing corresponding applications, which are based on creating thresholds for the images and detecting threshold values.

0.05-10 teraflops, preferably 0.25-5 teraflops, with a calculating power corresponding to 600 Mb/s, are preferably used for the analysis of the images. This calculating power is preferably provided using image-analysis processor cards designed specifically for it.

FIGS. 2a and 2b show a diagram of the implementation of the system 12 according to the invention. The system 12 includes cameras 14 for taking images of the paper web 10 continuously in several consecutive positions from the same location in the width direction of the web. The system 12 also includes lighting means 44 for illuminating the web 10 as desired during imaging. Images are taken of the web 10 using the cameras 14 in such a way that the web 10 is imaged in its entirety in its direction of movement, i.e. continuously. Thus, points that are not imaged do not appear in the position in the width direction of the web that is being imaged. Imaging of the web may have to be momentarily interrupted, for example, for washing a camera. Such an interruption is, however, very temporary and the web is essentially imaged continuously. The system 12 also includes a processing unit 54 for analysing the images taken by the camera 14 and for detecting deviations from the images by image analysis. The images are analysed from start to finish in the processing unit 54 and the result of the analysis is displayed to the operator at the operation station 22. The operation station 22 is used to control the system. In addition, the system 12 includes a host unit 56 for timing and controlling the imaging and lighting. The lighting and imaging should take place as desired, so that the desired aspects can be detected from the images as planned. In the system according to the invention, the images taken from each position are analysed entirely mechanically in the processing unit, after taking the images for the image-analysis method. The analysis is performed at least at the imaging frequency. Image analysis is performed to find deviations. Each deviation found in the image analysis is arranged to be displayed automatically to the operator as an event chain displayed in the user interface 21. The event chain is arranged to be created between deviation images by calculating default position data in the next position for each deviation found in the first position. The above expression first position refers to the first position at which the deviation is detected. The position data, of a detected deviation, at the position following the first position, at which the deviation is detected, is arranged to be compared, using selected criteria, with the assumed position data of the deviation. Each deviation is separated as belonging to some event chain. In its entirety, the mechanical and immediate analysis, made at least at the imaging frequency, together with predictive synchronization, makes the process real-time. The deviations found in the analysis are arranged to be shown in their essential parts to the operator automatically by the operation station immediately after analysis. Thus the operator does not perform the analysis, but only examines the results of the analysis.

The processing unit 54 shown in FIG. 2 includes means for recognizing patterns from an image. Pattern recognition is important especially in creating an event chain, which also takes place in the processing unit.

In the processing unit 54 of the system 12 shown in FIGS. 2a and 2b, there is power of 0.05-10 teraflops, preferably 0.25-5 teraflops, per camera 14, the image stream coming from which is 600 Mb/s. As the processing unit 54 contains calculating power of 0.05-10 teraflops, preferably 0.25-5 teraflops, per camera 14, the image stream coming from which is 600 Mb/s, completely new types of methods can be used in analysing a moving web. Such methods can be used to detect defects, the detection of which has not been possible using method based on thresholds, for example. As the processing unit contains power of more than 0.1 teraflops, the processing unit can be used to process images taken as a continuous flow from a web moving at more than 100 m/min, which web is recorded at an accuracy in the order of millimetres. Thus a single pixel of a matrix camera corresponds to an area of a desired size of the web, which is typically in the order of millimetres at most.

The system can be implemented using line or matrix cameras, but is advantageously implemented using matrix cameras. In a matrix camera the image can be scaled as desired in different directions and the imaging speed can be as much as 1000 images per second. Such a camera is particularly suitable for high-speed paper machines and narrow observation positions. Cameras based on the same architecture can be used in the entire system. In that case, the imaging parameters and the calculation algorithms are adapted to suit the task.

In the system, the image analyses are performed from uncompressed images and the results too are preferably displayed in an uncompressed form. When performing image analyses from uncompressed images, better analysis results than previously can be achieved. In addition, when displaying the analysis results as uncompressed images the operator will see the deviations accurately from the images. Such an implementation of the system demands an entirely new type of technology.

The system 12 shown in FIG. 2a includes at least one buffer memory 60, 64, with space for images of the web over a period of 0.5-30 minutes. Essentially all the images are stored momentarily in the buffer memory 60, 64, which is preferably a ring memory, in which the newest image is always stored on top of the oldest one. Thus the ring buffer always contains the most recent images for a predefined period of time. The buffer memory belonging to the system can be an uncompressed buffer memory 60, in which all the images are stored momentarily in an uncompressed form. There is no need to unnecessarily increase the size of the uncompressed buffer memory, so that is will have space for uncompressed images from a period of 0.5-5 minutes. At any time when using the system a desired image can be retrieved from the buffer memory for display. The storage of images in the buffer memory ceases is a disturbance of a defined type takes place in the machine. Such a disturbance can be, for example, a web break on the paper machine. The images from the time preceding the disturbance will then be in the buffer memory. The uncompressed very accurate images will give a better point of departure than before for detecting the causes of the disturbance. The images in the memory in question are not analysed mechanically, but instead are stored for detecting the reasons after, for example, a possible break.

The system 12 shown in FIGS. 2a and 2b also includes permanent storage media 62, in which the deviation images are stored. A defect, i.e. deviation image is an image in which there is a deviation that meets set conditions. The number of deviation images is very small compared to the total number of images taken. The deviation images are stored as such in an uncompressed form in the permanent storage media for later examination. Preferably only the images, in which deviations have been detected, are stored permanently. Thus the capacity of the permanent storage media can be used effectively for storing precisely the images that are of central importance.

The buffer memory belonging to the system 12 according to the invention shown in FIG. 2a can be a compressed buffer memory 64, in which all the images taken by the cameras 14 are stored in a compressed forms. The compressed buffer memory contains the most recent images of the web in a compressed form. Any of the images stored in the compressed buffer memory can be retrieved for display. There is space in the compressed buffer memory for images from a period of 5-30 minutes. If necessary, the size of the buffer memory can be increased and images from a longer time can be stored in a compressed form, but 5-30 minutes will generally be sufficient.

In the system shown in FIGS. 2a and 2b, the operation station 22 is used to control the entire system 12. More closely examined, the host unit 56 controls the lighting means 44. The lighting means 44 can be lighting means 45 that produce continuous light, or strobe lighting means 46. Preferably at least some of the lighting means 44 are strobe-lighting means 46, so that some of the lighting events can be made very fast. Fast lighting events are required when images are taken of a rapidly-moving web, the aspects of which requiring examination are in the order of a millimetre or less. Strobe-lighting elements are also used in narrow observation positions, in order to produce sufficiently fast lighting. In each observation position, there is preferably only one camera imaging each point in the width direction of the web. In the same observation position there are several cameras, so that each camera can be aimed as desired at a narrower part of the web. The web is imaged in several observation positions, so that event chains are created between images of deviations detected at them.

The exposure time can be adjusted by means of the flash time of the strobe-lighting elements or the opening duration of the shutters in the cameras. When the exposure time of the web is implemented using adjustment of the shutters of the cameras, continuous illumination can be used in the lighting. The use of strobe-lighting elements can achieve very short exposure times, for example, 5-10 microseconds. The illumination of the web can take place from the same side of the web as the camera. On the other hand, the lighting element can be located on the opposite side of the web to the camera.

By means of the system 12 shown in FIGS. 2a and 2b, very rapidly moving paper webs can be monitored. The speed of the web can be hundreds of meters per minute, in which case the illumination of the web is implemented as follows. The host unit 56 first commands the cameras 14 to open their shutters (ERS=Electronic Rolling Shutter). After this, comes a safety time, which is used to ensure that the shutters of all the cameras 14 open. After the safety time, the shutters of the cameras 14 are sure to be open and the strobe-lighting elements 46 are commanded to light for the desired time. When the strobe-lighting elements switch off after the desired time, the shutters of the cameras 14 still remain open for a safety time, after which the shutters of the cameras 14 close and the data is read to the processing unit 54 over a bus 68. The exposure time is adjusted as desired by altering the flash time of the strobe-lighting elements. A bus 66 runs from the host unit 56 to the strobe-lighting elements 46 for transmitting the lighting command. A bus 58 runs to the cameras 14 for transmitting the imaging command. The images taken by the cameras 14, i.e. the data to be analysed, travel to the processing unit 54, in which the image analysis is performed, over a bus 68. Preferably a single imaging command is enough for the cameras, on the basis of which the cameras are programmed to open the shutters and close them after the desired time, and to read the data from the imaging elements for transmission to the processing unit. The safety time is used to ensure that the shutters of all the cameras are open when the lighting elements flash. In such a very fast system, in which up to hundreds of images are taken each second, delays very easily become significant. Due to the disturbing influence of the delays, safety times are used to minimize the detrimental effects of the delays. Significant delays appears in the signals transmitted to the cameras and especially in the operation of the cameras. The arrangement described above is only one example for solving the problems brought by the delays. The significance of delays increases as the speed of the web increases. The exposure time can also be adjusted, for example, for webs moving at 100 m/min by means of the shutters of the cameras. As cameras develop, the exposure time can also be adjusted as desired by means of the shutters of the cameras for even webs moving rapidly at thousands of metres a minute.

In the system according to the invention shown in FIG. 2a, data is transferred between the cameras 14 and the processing unit 54 in buses 68, which are fibre-optic cables 18. It is nearly impossible to achieve the necessary transfer speeds using copper conductors, as the data-transfer capacity required is typically Gigabytes per second. Fibre-optics can be used to implement the necessary transfer speeds more economically than by using, for example, copper conductors. The processing unit 54 is connected to a data-transfer network 19. The permanent storage media 62, the operation station 22, and the host unit 56 too are connected to the data-transfer network 19. The data-transfer network 19 is then between the processing unit 54 and the operation station 22. By means of such a construction, a system can be implemented, in which the data-transfer capacity is optimized for each purpose. The use of fibre-optics will implement economically the transfer of large amounts of data, as using a fibre-optic bus 68, 10 Gb/s, for example, can be used as the data-transfer rate. The speed of a normal data-transfer network 19, for example a LAN network 20, the speed can be, for example, 1 Gb/s. A normal data-transfer network is sufficient to transfer information after processing. The amount of information to be transferred diminishes considerably in processing, as, when the paper-web production process, i.e. the paper machine, is operating normally, deviation images account for less than 1% of the total number of images taken by the cameras 14.

In the cameras, there is a camera processor, which is used to send the image in a digital form. The camera processor in connection with at least one camera is used to send the processing unit a set of measurement data relating to the camera and the environment. In connection with a camera there are measurement means 67 (FIGS. 2a and 2b), by means of which the ambient temperature of the camera, among other things, is measured.

FIG. 2a shows an implementation diagram of the system 12 according to the invention, when using several cameras 14 to a single processing unit 54. A system 12, in which a single processing unit 54 is used to several cameras 14, can be advantageously used in upgrades. It will allow old hardware, for example cameras, to then be re-utilized.

FIG. 2b shows an implementation diagram of the system 12 according to the invention, when using a single processing unit 54 and preferably a single image-analysis processor card to a single camera 14. The system 12, in which a single processing unit 54 is used to a single camera 14 is advantageous for use in new apparatuses. The processing unit 54 can then be located in connection with the camera 14. The processing unit located in connection with the camera can be in the same case as the camera, or separately in the immediate vicinity of the camera. The images are transferred from the cameras 54 to the processing unit 54 using fibre-optic cables, as in FIG. 2a, or else the camera is directly connected to the processing unit 54. When the processing units 54 are located in connection with the cameras 14, data transfer is preferably implemented forward from the processing unit 54 by means of a wireless data-transfer network. In the implementation according to FIG. 2b too, in a preferred embodiment the processing unit 54 includes buffer memories 60 and 64, as shown in FIG. 2a.

FIG. 3 shows a paper machine 70, i.e. a paper machine utilizing the system according to the invention. In the paper machine 70, the paper web 10 being formed is investigated. Webs typically move at 100-10 000 m/min, preferably 400-3500 m/min. Monitoring of webs on a web-forming machine is important, as by monitoring the web it is possible to predict the direction of development of the process and thus to control the process in an anticipatory manner. The product web, i.e. the paper web can contain many very small defects, for the detection of which the method according to the invention is well suited. In the product web, i.e. the paper web, even the smallest deviations can be analysed using the method according to the invention, as the analysis takes place entirely mechanically.

FIG. 3 shows a web-forming machine, i.e. a paper machine 70. The method according to the invention is very advantageously suited to the monitoring of a paper web 10. At the observation positions in the paper machine 70, the product web, i.e. paper web can be imaged only over very small areas, for example, over a distance of less than 200 mm. At any one time, the web is typically images over a distance of 10-400 mm, typically 20-200 mm. As imaging is possible over short distances, the process can be monitored using the method according to the invention in locations, in which this was previously impossible. In addition, the web moves very rapidly, for example more than 400 m/min, in which case the method and system described above are very suitable for monitoring it. Deviations detected by the system are preferably arranged to be linked using predictive synchronization. Predictive synchronization also notifies the operator as to where in the web there are deviations, which might possibly cause a web break, or lead to damage to the paper machine. On a paper machine, the predictability of the process offers considerable advantages, as it permits web breaks to be avoided. In addition, predictability permits the paper machine to be controlled so as to avoid machine damage. Avoidable machine damage can be, for example, damage to the rolls of a matt calender. The rolls of a matt calender are very easily damaged, so that they can be damaged, for example, if a fibre lump goes between them. Predictive control permits the matt-calender nip to be opened or the pressure to be reduced, before the fibre lump reaches the nip. If the pressure is reduced, or the nip is completely open when the fibre lump reaches the nip, the matt calender's rolls will not be damaged.

In FIG. 3, the camera 14 monitoring deviations in the quality of the product web, i.e. in the paper web 10, before reeling is shown differently to the other cameras. In this observation position the illumination is preferably based on through-lighting using a strobe-lighting element 46. The other cameras 14 shown in FIG. 3, on the other hand, typically image the web in continuous light, the source of which is on the same side as the camera. If there is enough space on the machine, imaging based on strobe-lighting and/or through-lighting can be placed elsewhere too. Imaging based on strobe-lighting can be advantageously located, for example, at the wire section and/or before the coating equipment. The strobe-lighting can be on the same or opposite side of the web as the cameras. Lighting elements that are on the opposite side of the web to the camera are preferably strobe-lighting elements. The desired number of cameras are positioned on the machine at each location that it is desired to image. If through-lighting by strobe-lighting elements is used for illumination, and the precision of the light cell of the cameras is in the order of 600*800 pixels, a bank of 5-30, preferably 10-20 cameras is placed laterally on a 10-metre wide machine. At a point, in turn, at which illumination takes place by continuous lighting, fewer cameras are placed. At such points, there are 2-10, preferably 2-4 cameras. When using cameras with a high precision that the said 600*800 pixels, fewer cameras will be needed for imaging. The example numbers given above thus depend on the number of pixels in the image cells of the cameras.

When monitoring a paper web using defect-detection cameras, a pixel of the image cell in them can be set to correspond to an area of the web of, for example 0.63*0.63 mm. In turn, when monitoring, for example, using press-nip process-monitoring, i.e. web-break cameras, a single pixel of the camera's image cell can correspond to an area of web of 20*20 mm. The aforementioned difference is caused by the different adjustment of the exposure times of the cameras and by the precision required. A defect-detection camera detects defects with a resolution that is 10-200 times more, typically about 50 times more, precise than that of process-monitoring cameras. For example, if a hole with a diameter of 10 mm is detected at the reeler, it will probably have already been detected at the press, even if continuous illumination were used there, provided that the hole already existed at that point.

The system 12 according to the invention shown in FIG. 3 is used in a paper machine 70. The system according to the invention allows web-break and defect-detection systems to be replaced with a single, unified, real-time system, in which the images are analysed mechanically in real time. The hardware and the software will then be the same in all process monitoring and quality control. If the hardware and software are the same, an event chain can be created from start to finish of the process. As the image analysis takes place in real time and by using predictive synchronization, an even chain can be created in real-time as a deviation progresses through the process. In addition, a single unified interface permits an unlimited number of cameras and other components. The deviations being sought are defects in the paper or web breaks. Web breaks and defects in the web at all points in the process are caused by similar process disturbances, such as slime, a non-functioning couch squirt, or plucking in a press felt, so that using a single system to monitor them is very advantageous. The system according to the invention can be used to create event chains of detected defects. When upgrading existing apparatuses, their components can be utilized in part. For example, cameras 14, lighting elements, and the operation station 22 from old systems can be utilized at least in part, but at least the processing unit 54 must be replaced with a new one.

In the system according to the invention shown in FIG. 3, the images taken by the cameras 14 are transferred over the bus 68 to the system cabinet 16, in which image analysis is performed on them. The image analysis is performed using the processing unit 54 in the system cabinet 16. The processing unit 54 performing the image analysis consists of image-analysis processing cards 74. The processing unit and thus the image-analysis cards can also be in connection with the cameras. Placing the processing unit 54 consisting of image-analysis processor cards 74 in the system cabinet 16 is advantageous when upgrading old systems, as it permits a good packing density of the processing power. Placing the processing units in connection with the cameras is in turn advantageous when creating entirely new systems. The term processing units 54 belonging in connection with the cameras 14 also refers to processing units 54 located in terminal boxes 36.

FIG. 4 shows the construction of the system, from the cameras 14 to the operation station 22. The images are transferred from the cameras 14 through a terminal box 36 to the system cabinet 14 by a bus 68, which is preferably implemented using fibre-optic cables 18. In this embodiment, the processing unit 54, which contains image-analysis processing cards 74, is in the system cabinet 16. The image-analysis cards 74 are used to perform image analysis on the images received from the cameras 14, i.e. the image analysis is performed entirely mechanically. As a result of the image analysis, each image either contains or does not contain a deviation. If there is no deviation in an image, it is bypassed. The results of the image analysis are forwarded from the system cabinet 16 using a normal data-transfer network 19, such as a LAN 20. A one Gb/s LAN will be sufficiently fast for a real multi-processor environment, in which case the transfer time of, for example, a 30-second film can be 0.4 seconds. A LAN is more economical to implement than a fibre-optic based network. The data transfer is preferably based on a WLAN, because in that case there will be fewer restrictions on the placing of the apparatuses.

The operation station 22 belonging to the system shown in FIG. 4 contains a dual-display 88 and a thin desktop PC 86. The desktop PC 86 can contain 4 Gb of memory and a 1-Gb connection to the data-transfer network. The operation station is typically installed in the control room. Parallel operation stations can be installed at the operation station. The dual-display 86 contains two 19″ TFT displays 84 for dual-display operation. In addition, the operation station 22 includes a mouse and a keyboard 90.

The size of the system cabinet 16 shown in FIG. 4 can be 800 mm (W)×800 mm (D)×2100 mm (H) and is generally located in a space intended for a cross-connection or similar electronics. The system cabinet is equipped with fans, which circulate cooling air through air ducts to points requiring cooling. There are doors in the front and back of the system cabinet, through which there is access for working with the equipment and connections. At the sides of the module racks there is space for cabling and air ducts. In the system cabinet 16 there are two 1-Gb/s port 24 switches, a 1500-watt UPS, power-supply devices, and a firewall, as well as two card racks 52 for the image-analysis processor cards 74.

Two card racks 52 fit into the system cabinet of the system shown in FIG. 4. A maximum of 14 image-analysis processing cards 74 fit into a card rack 52. Thus 28 image-analysis processing cards 74 will fit into the system cabinet 16, one of which processes the signals, i.e. images coming from four cameras. Thus the image-analysis processing cards 74 in the system cabinet 16 can process the signals from 112 cameras. Each camera's processing partition on the image-analysis processing card is independent, in other words each camera and its partition on the processing card form an independent and smart camera. By using a singles image-analysis processing card for processing the images received from four cameras a good packing density and compact system are achieved. The number of image-analysis processor cards 74 required depends on the number of cameras 14. A camera server 80 is also located in the system cabinet 16. A Xeon 3.2 GHz with 4 Gb of memory and 6*146 SCSI high-speed fault-tolerant hard disks can act as the camera server. In addition, a data server 82 is located in the system cabinet 16. A Xeon 3.2 GHz with 2 Gb of memory and 6*146 SCSI high-speed fault-tolerant hard disks act as the data server.

The location referred to above of the image-analysis processing cards in the system cabinet is only one alternative and the image-analysis processor cards can also be located, for example, in connection with the cameras. If the image-analysis processor cards are located in connection with the cameras, one card will preferably process only the images coming from a single camera. In that case, an image-analysis processing card will typically correspond to about one-quarter of the image-analysis processing cards located in cabinets. The digital images are transferred from the cameras 14 to the processing cards 74 over a bus 68. There is a 1 Gb/s LAN connection 20 from the system cabinet 16 to the operation station 22. If necessary, the system can be implemented to be compatible with the old operation stations.

FIG. 5 shows one possible construction of the system according to the invention from the system cabinet 16 to the cameras 14 and the lighting means 44. Data transfer between the image-analysis processor cards 74 in the system cabinet 16 and the cameras 14 takes place over a fibre-optic cable 18. Data transfer between the camera 14 and the system cabinet 16 is preferably two-way. In two-way data transfer images in digital form, as well as measurement data such as the camera temperature, are transferred from the camera to the processor. The camera, in turn, is sent control data, such as commands to the rotation head and zoom, camera settings, and a wash-event command. The terminal box 36 installed near the camera is of acid-resistant steel and IP 67 shielded. Water, air, and electricity are transferred to the camera 14 from the terminal box 36 in a conductor 38, which consists of several parts. The conductor 38 includes a fibre-optic cable 19, in which the images taken by the camera are transferred to the terminal box 36. The conductor 38 between the camera 14 and the terminal box 36 is a standard cable, which contains all the necessary inputs and signals. The length of the fibre-optic cable acting as the conductor 38 can be selected to be, for example, 3, 6, or 10 metres. Voltage from the terminal box 36 to the camera 14 travels through the conductor 38. The voltage is converted by a transformer 39 in the terminal box 36 to the level used by the camera 14, which can be 24 V. Power comes to the transformer through the cable 40. Water is taken through a conductor 40′ to the terminal box, in which a throttle valve 35 is used to regulate the pressure of the water to the desired level. Air is taken to the terminal box through a conductor 40′ and its pressure is regulated as desired by means of a throttle valve 37. Electricity is taken from the terminal box 36 to the lighting means 44 through a conductor 42. In connection with the camera there is an FPGA camera processor, which takes care of the control/measurement signals in the fibre-optic cable 19. The camera process can also be located in the terminal box.

FIG. 6a shows a camera 14, which is placed in a protective camera case 48. The camera case 48 is of stainless steel, which can also be acid-resistant and polished. In connection with the camera case there is an integrated wiper 50 and washer 51. The wiper is strong and will withstand all the high-pressure sprays that typically take place during the washing of the paper machine. The washer is used to spray the glass with water or a washing solution, to detach dirt. During washing and wiping the analyses are masked. The wash water can be collected and led away in a controlled manner, using a separate collector attached to the case. The rubber of the wiper can be the normal micro-edge type used in cars. At the edges of the glass 49 of the camera case 48 there are grooves 47, in which the rubber of the wiper can be wiped clean after each wiping sweep. Inside the camera case is a polyurethane thermal lining, which effectively insulates external heat from penetrating the camera case. A small airflow is using to transfer away heat that has developed inside the camera case. A throttle valve 37 in the terminal box 36 (FIG. 5) is used to regulate the airflow. The airflow is sufficient to cool the camera, if the ambient temperature is less than 60° C. Higher ambient temperatures will require boosted cooling, which can be implemented using a vortex cooler. The camera can be perfectly well located in even demanding locations on the machine, as long as the camera case is cooled and equipped with a washer/wiper apparatus.

FIG. 6b shows the camera's mounting bracket 15. The camera case is attached to the machine by means of the mounting bracket, which is made from acid-resistant steel. The mounting bracket permits free alignment. There are several models of bracket, according to the requirements of the mounting locations.

The camera is used for monitoring the web is very many types of locations. The imaging and monitoring of the web can take place at many accuracies, depending on the purpose. In general process monitoring, i.e. in web control, the imaging precision can be about 20 mm*20 mm. When seeking defects in the end product, on the other hand, the imaging precision can be 0.6 mm*0.6 mm. The term imaging precision refers to the smallest detail found in the image. Because the required imaging precision varies, many different types of camera are used in imaging. The camera can be a black-and-white camera, which will provide a sensitive exposure and a fast shutter time. The camera used can also be a colour/black-and-white camera, which will provide a high sensitivity. The use of relief-image and dual-speed cameras can also be advantageous when upgrading old systems. Preferably, at least in defect detection, fully digital matrix cameras are used, which have image elements with a size in the order of megapixels. In other words, at some of the cameras belonging to the system will be matrix cameras. In such cameras, the image can be scaled in different directions and the imaging speed can be up to 1000 images a second. A matrix camera is especially suitable for defect detection and for high-speed machines with narrow gaps in the machine. The system can also be implemented using only matrix cameras. The cameras that are mutually similar will facilitate design and possible repairs. In addition, matrix operations can be used in the image analysis.

In paper-web monitoring, i.e. web-break monitoring PAL black-and-white cameras can be used. Such a camera can be an Ikegami ICD-48E camera, in which there are 768×572 lines and a sensitivity of 0.007 f 1.0. The camera in question has a built-in DSP control function. The shutter speed is up to 1/100 000 s. The lens is a Pentax Cosmicar 8-48 mm Zoom, f 1.0. In connection with the cameras there is a camera processor for converting the image to a digital form and transferring it in fibre. The camera processor also acts as a control processor for the camera and controls the I/O operations on the basis of control commands sent over fibre. On the basis of the control commands, operation of, for example, the rotation head, the motorized zoom, the camera's control settings, and the washer/wiper apparatus takes place.

High-speed cameras are used in defect detection and process analysis. High-speed cameras are preferably matrix cameras, which permit the desired number of lines and pixels to be read at the desired speed. Such a camera is preferably implemented using CCD technology, when a very high sensitivity will be achieved. The camera is digital and send the images over a Camlink connection at a 10-bit resolution. The camera's own DSP processor can include LUT correction, when digital conversion to a higher resolution is made around the mean value of the subject being imaged.

The matrix cameras presently on the market can provide a full image (all the pixels and lines included), for example 120 times a second. However, in defect detection about 250 lines are typically used in the machine direction, which the maximum imaging speed will be 250 images/s. When using only 40 lines/image, already 1000 images/s will be obtained. It is also possible to alter the image format and thus adapt the shape of the pixel better to the subject being imaged. For example, when seeking coating streaks, an image format can be selected, in which the CD pixel width is adapted to the width of the coating streak being sought. In addition, it should be noted that cameras develop all the time, so that in the future the image cell of a camera may contain more pixels than at present. In the future, it will be possible to transfer data from cameras faster than at present. More full images will then be transferred in a second.

The applications of a high-speed camera in process control are narrow machine gaps, in which a slow camera is not able to produce a continuous image of a rapidly-moving web. A narrow machine gap, where slow cameras will have problems, can be, for example, at a centre roll. High-speed cameras can also be used to provide a precise image, for example, of the base paper prior to a coating station, so that better information can be gained of disturbance. In process-control cameras, it is possible to use, for example, a Pentax Cosmicar 8-48 mm f 1.0 zoom lens and in defect detection a Pentax 6 or 8.5 mm f 1.2 fixed-focus lens. The focal length of the lens is determined by the width of the viewing area of the camera and according to the installation distance of the camera.

High-speed cameras like process-control cameras can be installed in a camera case like that shown in FIG. 6a. When using high-speed cameras for defect detection, they are mounted in a separate camera beam, which can be located above the web or, in special cases, under it. Placing the cameras above the web is preferable, as in that case the shield covering the lenses of the cameras will not dirty as much as when located under the paper web.

The cross section of the camera beam can have an elliptical shape, in which case the height of the profile can be 330 mm and the width at the centre 280 mm in the machine direction. The camera beam can be manufactured as a single piece from aluminium using the extrusion method. Blast-air ducts, which also act as stiffeners of the structure, are integrated in the structure. The air is distributed from the blast-air ducts in a controlled manner, so that all the cameras, irrespective of the length of the beam, will receive a sufficient amount of blast air. The aluminium, from which the camera beam is made, is typically anodized and epoxy-painted. This will in practice create a corrosion-resistance structure. The cameras are attached to mounting rails inside the beam and their alignments can be adjusted. The camera processor is installed at the side of the camera on the same mounting rail. Traffic between the camera processor and the central unit takes place typically over fibre-optic cables. During operation, the cameras are focussed on the web through a hole in the lower surface of the beam. Blast comes out of the hole at a high velocity and prevents dirt from entering the beam. If the blast air is cut off for some reasons, or its amount drops excessively, the opening closes automatically. Openings for service hatches are machined in the other side of the camera beam, through which the cameras can be serviced. The camera beam is installed either on the end feet of the beam or permanently on the frame structures of the paper machine, with the aid of a mounting flange. The camera beam can be placed, for example, at a distance of 650 mm from the web, when it can be easily fitted to even a cramped machine.

FIG. 6c shows an example of the lighting means 44. Lighting that takes place from the same side of the web as the camera is typically used in web-break monitoring. Lighting of this kind can take place, for example, using a 150-W multi-metal lamp, which is IP67 encased. Multi-metal lamps are available with different aperture angles and outputs. Typical outputs are 150, 250, and 400 W. Greater outputs are used in locations, in which a greater amount of light is necessary. A washer/wiper apparatus similar to that used with the camera can be installed on the lamp. Such a washer/wiper apparatus will ensure that the lamp remains clean in even difficult conditions.

When using strobe-lighting elements in the lighting, the strobe light is preferably implemented using white LED lamps. Such LED lamps are durable and last typically more than five years in use. In addition, the strove-light pulse produced using a white LED lamp can be, for example, only 5-10 microseconds. By using such a short exposure time very precise images of the web will be obtained. In addition, a short exposure time permits a rapidly-moving web to be imaged continuously in a short observation position. In practice, a paper web, which moves thousands of metres each minute, can then be examined with a precision of under a millimetre. A lighting beam, with a profile corresponding to that of the camera beam, can be formed from LED lamps. On the surface of the lighting beam, from which the light is emitted, there is a diffusion glass. The lighting beam is 200 mm in the machine direction and extends about 200 mm over the edges of the web at both ends. Under the glass is an LED light unit, which is formed of units 500 mm long (in the cross direction of the machine) and 200 mm wide (in the machine direction). Enough units are installed permanently against each other in the cross direction that the illumination field extends over the edges of the web in all conditions. In each unit, there are about 1000 LED lamps. The LED lamps are high-output and are installed, by means of the surface-mounting technique, on a base like a circuit card, which also acts as a thermal conductor. Each unit's power-supply and control unit is on the opposite side of the base to the LED lamps. The lighting takes place by switching on the LED units for the desired period of time, typically 5-10 microseconds, depending on the paper grade. If the LED units in the lighting beam require servicing, there are service hatches in the sides of the lighting beam, through which the entire unit can be removed for servicing/replacement. Cooling air is led from the blast ducts to the LED units, in such a way that all the LED units receive the same amount of air. The diffusion glass is formed from several pieces, which are fitted precisely to each other. The pieces are pressed against each other at a constant pressure, irrespective of thermal expansion. The edges of the beam and the glass in the machine direction are shaped in such a way that they permit momentary contact with the web. Thus the beam can be cleaned by pressing it onto the web momentarily.

In connection with the lighting beam there is a lowering mechanism, which can be used to lower the end of the lighting beam on the front side below the measuring position when necessary. The lowering distance can be, for example, 600 mm, and the lowering mechanism can be implemented with an electric motor and rack. When the lighting beam becomes dirty, for example, during production or a web break, the beam can be raised against the web for a few seconds and the moving web allowed to wipe the beam clean. Automatic cleaning of this kind can be programmed to take place after a desired type of event, which can be, for example, a web break or reel change. Cleaning can also be implemented at desired intervals. The lighting beam can be raised using rubber cushions, to which compressed air is fed.

When using continuous light to illuminate the web, the exposure time should be adjusted suitably, for example, by using the shutters in the cameras. The camera shutter speed can be, for example, 1/10 000 second, but in many applications a shutter speed of even 1/3000 second will be enough. If the web moves at 2400 m/min, it will move 40 000 mm in a second. If the shutter speed, i.e. the exposure time is 1/3000 second, the web will move about 13 mm during the exposure. If, on the other hand, the shutter speed is 1/10 000 second, the web will move only 4 mm during the exposure time. 10-20 mm is usually sufficient as an imaging precision, but if necessary the imaging precision can be increased, as described above, by shortening the exposure time. However, shortening the exposure time will reduce the illumination. In the future, when the cells of cameras become more sensitive and shutter speeds increase, even shorter exposure times will be used, which will permit the even more precise imaging of the web. The precision of imaging in events of this kind taking place in continuous light using present cameras generally is not limited by the size of the pixels, but by the distance traveled by the web during the exposure time. In the cross direction of the web things can be seen more precisely, because there is no significant movement in the cross direction of the web.

Using strobe light, the exposure time can be made shorter than with continuous light, so that a more precise image of the web will be obtained with strobe light than with continuous light. The light pulses can be, for example, of a duration of 5 microseconds, when a pixel resolution of 0.63 mm*0.63 mm will be achieved at all speeds up to 7500 m/min. Using the example referred to above, holes in the web can be detected starting from a size of 0.4 mm, wrinkles from a width of 0.3 mm, and edge fraying from an opening of 0.5 mm.

FIG. 7 shows the image-analysis processing card 74, which contains the calculating power required by the invention. The image-analysis processor card 74, which is optimized for analysing the images coming from four cameras, contains calculating power of 1 teraflop. Thus the calculating power per camera is 0.25 teraflops. The calculating power per camera should generally be at least 0.1 teraflops, in order that the precise images taken of a rapidly-moving web can be analysed mechanically in real time. 100 teraflops is sufficient calculating power when the amount of data increases as the individual images become more precise and the number of images increases. The number of images will increase further, as the processes being imaged become faster.

A single image-analysis processing card can correspond to the information coming from even several cameras. On the other hand, it is possible for the data coming from a single camera to be processed using several image-analysis cards. There is preferably one image-analysis processor card to each camera, making it easy to place the image-analysis processor card in connection with the camera or in the terminal box.

The image-analysis processor card, which has a powerful FPGA and several power-DSPs optimized for image processing, permits the processing of image streams consisting of up to 300 precise images per second. The camera being used can be equipped with, for example, a 10-bit 768×572-pixel image cell. The size of a single precise image for processing is 4.2 Mb. When 150 such images are taken each second, the image stream to be examined will be about 600 Mb/s. The calculating power required for examining an image stream of this kind is, according to the example, 0.25 teraflops per camera. Typically, a calculating power of 0.05-10 teraflops, preferably 0.25-5 teraflops per camera, the image stream from which is 600 Mb/s, is required. Of course the analysing power can be even more, but this will provide only minimal additional benefit.

The image-analysis process shown in FIG. 7 is optimized for analysing the images coming from four cameras. The card includes four input connectors 77, in which case the images coming from each camera can be routed to the image-analysis processor card 74 through its own input connector 77. After the image analysis, the information is routed out through a single output connector 79. Special processors 69 are used in the implementation of the image-analysis processor card 74, by means of which capacity suitable for calculating the images of at least 0.1, preferably 0.25 teraflops per camera, the image stream coming from which is 600 Mb/s, is achieved. Matrix operations are preferably used in the analysis of the images, as they can be used to analyse bit maps effectively. In the image-analysis processor card 74, there is one processor 75 intended specially for the processing of matrix operations, which is preferably the FPGA 75′ (Field-Programmable Gate Array). In addition, the image-analysis processor card has nine permanently programmed processors 73, which are preferably DSPs 73′ (Digital Signal Processor).

The image-analysis processor card is manufactured using the surface-mounting technique and the components are selected with a view to a high reliability. The nominal MTBF of the card is 100 years. The combined calculating power of the card is in the order of 1 teraflop, i.e. more than the combined calculating power of more than 100 Pentium®-level PCs (January 2006). The image-analysis processor card is used to process uncompressed images, i.e. the image analyses are performed on uncompressed images. In the image analysis, the images are processed by an image-analysis series comprising the FPDA and two DSPs. In the image analysis, automatic and continuous correction of image errors and unevenness is performed. The most important stage of the image analysis is a search for deviating events and defects, using new image-analysis mathematics and uncompressed images. After this, the events and defects are classified and displayed and an alarm is given if necessary.

The image analysis is preferably performed in a single stage. In other words, a lighter preliminary analysis and an actual analysis are not performed on the image material, as is done in the methods according to the prior art. A single-stage image analysis is advantageous, as information is always lost in a lighter preliminary analysis. The information lost in the preliminary analysis cannot be restored later, no matter how good the actual analysis might be. The image-analysis processor card is designed to perform a single-stage image analysis.

As the amount of information coming for analysis from a single camera increases, for example, when the images are made more precise, or the imaging interval is further reduced, the image-analysis processor card 74 shown in FIG. 7 can be adapted to process only the images coming from a single camera. Only a single input connector will then be required. Using such an image-analysis processor card, the images coming from the camera will be processed in four parallel processes. The processing can be implemented by routing only every fourth image to the same image-analysis series. The consecutive images are then processed in parallel image-analysis series, which contain the FPGA and two DSPs. By using such a card, it is possible to process about 600 4.2 Mb images a second coming from a single camera. Thus the processing on the card can process about 2500 Mb/s. A calculating power of at least 0.2-40 teraflops, preferably 1-20 teraflops for each camera, the image stream coming from which is 2500 Mb/s, will typically be required.

The image-analysis card 74 shown in FIG. 7 also includes an uncompressed buffer memory 60 for storing all the images in an uncompressed form. The uncompressed buffer memory has space for images from a period of 0.5-5 minutes. In an application used on a paper machine, the uncompressed buffer memory has space for 1000 images. The defect images are stored in permanent storage media 62, from where they can be retrieved later (FIG. 2). The image-analysis processor card 74 also includes a compressed buffer memory 64, which typically has space for images from a period of 5-30 minutes. In an application used on a paper machine, the compressed buffer memory has space for images from a period of 7 minutes. The compressing processor forms a digital image stream from the cameras in real time, which can be retrieved over switches to the operation station. RAM memories are used as the buffer memories 60, 64, so that storage can be performed at the speed required. Hard disks are used in turn as the permanent storage media used to store defect images.

The buffer memories can be located elsewhere in the system according to the invention than in connection with the image-analysis processor cards. The location of the buffer memories in connection with the image-analysis process cards is preferable, as in that case the entire image stream need not be moved farther than the image-analysis processor card. This allows a considerably lower data-transfer capacity to be used between the image-analysis processor card and the operation station than between the cameras and the image-analysis processor card.

FIGS. 8a and 8b show deviations 98, which are found using the method according to the invention. The deviations 98 found in FIGS. 8a and 8b are of the same type as those found by the human eye. Such detection can be used to find many defects that remain undetected using, for example, detection methods based on thresholds. The deviation found in FIG. 8a is backing roll marking 97, which is very difficult to detect. FIG. 8b, for its part, shows water-drip traces on the top layer in boxboard.

FIGS. 9-11 show a view of the user interface 21 of the system according to the invention. The user interface 21 operates using any work i.e. operation station whatever connected to a data-transfer, i.e. local area network. The display of the operation station using the user interface must have an adequate resolution. The user interface is preferably programmed using internet browser technology, so that the operation station will not require special application software. An operation station, to which two displays are connected using dual-display technology, is used as the main operation station. Dual-display technology is used to display to the operation defect-detection and special displays simultaneously, as well as automatic displays and further analyses of event sequences.

In the basis setting of the user interface 21, which is shown in FIGS. 9 and 11, the left-hand display 85 is reserved for the event sequences, which are shown automatically. Other data too can be shown in the left-hand display, but active operation is not performed in the display. An event sequence starts from a disturbance at some point of the production line. A frame 26, in which the first detected deviation is shown as a slowed uncompressed film, then opens in the left-hand upper corner of the left-hand display 85. The film typically consists of the images in which the deviation has been detected, plus two images before and after the disturbance. The operator then sees an entirely automatically presented depiction of the deviation. In the images the deviation is shown highlighted with background colours on another image, so that the operator can easily detect the deviations from even a large amount of information. The most important observation, i.e. the image in which the deviation is greatest when examined mathematically, remains in the frame 26. At the right-hand edge of the left-hand display 85, there is a diagram 34 of the paper machine, in which the paper machine is shown from top downwards. The camera locations and break sensors are shown in the image. The cameras, which have detected the change, are shown colour-coded. The image also shows the cross-direction location of the detected deviation. Once a disturbance has been detected by any subsequent camera, it can be attached to the same event sequence, i.e. the event chain with the aid of time-difference calculation, i.e. synchronization. A new frame 28 is then opened below the initial frame, in which all the other disturbances detected are shown in the order of arrival. If the disturbance ends up as a defect at the reeling drum, the image taken with the defect-detection cameras before reeling will remain the final image in the event stack. Correspondingly, in an event terminating in a web break, the top image in the stack will be that showing the event. If the operator wishes to examine the events of the various cameras afterwards, they use the paper-machine diagram for the purpose. When the operator selects a camera from the diagram by clicking on the camera, the related film material is shown on the display. Two simultaneous event sequences can be shown on the left-hand display 85. The sequences are shown next to each other, in which case two frames are used to show each of them. The sequences are colour coded. The cameras, which detected the deviation are shown in the same colour code along with the progress of the event. There can be more observed sequences too. If a third sequence too is detected, it is monitored and shown using colour code, but the image series is not automatically displayed. The image series is, of course, stored and is available for display. The system uses a classifier to classify all the observations. When classifying the observations, the observations are named and the event sequences to be displayed are selected according to priority. The event sequence with the highest priority is displayed at the left-hand side and that with the second highest priority to the right of it. The other event sequences can be retrieved from the memory.

A 19″ TFT display, for example, can be used as the display of the user interface. The operator can see from the user interface each case as an event chain. As the operator sees the deviations in real time, decisions can be made to correct the problems. The images of process and quality disturbances appear on the display automatically, so that manual operation is not required to retrieve the images. The images of the event chain are typically shown to the operator in an uncompressed form. The operator is informed of the formation, statistics, reports, trends, and profiles. A image from the first camera to detect a deviation can be shown in the uppermost frame 26 of the farthest left-hand side of the left-hand display 85 in FIGS. 9 and 11. The frame 28 below this can, in turn, show the images of other deviation observations from the same deviation. A second deviation caused by the first deviation detected can correspondingly be shown in the frame next to the frame 26. The images of deviation observations caused by the same deviation can, in turn, be shown in the frame 32 next to the frame 28. The paper-machine diagram 34 shows the machine positions where the deviations have been detected. Colours are exploited to illustrate the images. The images of a single deviation are shown with one colour, and those of another deviations with another colour.

The totality of the operation of the system permits real-time event monitoring. When the system detects a deviation in the web, it is displayed to the operator immediately. All the deviations found by the system are displayed to the operator automatically. If the deviations found by the system derive, on the basis of the synchronization calculation, from the same defect, the first of these is shown uppermost in the image while the image under it changes as the defect moves through the process. Thus the operator can follow the real-time development of the process and control the process if necessary. If a deviation detected from the paper web appears to be such that it will cause the web to break at the coating unit, this unit operation can be switched off. Thus the web will not break and tail threading will be avoided. Impurities in the web can sometimes even damage the process devices of the paper machine, for example, the rolls of a matt calender. If an impurity that may damage, for example, the rolls of a matt calender appears in the process, the pressure in the matt calender can be reduced, so that the rolls will not be damaged. In such ways for example, real-time monitoring of the process will bring considerable savings. In their entirety, all the events are displayed automatically, leaving the machine operator with only the role of monitor and observer. In practice, the defects and faults of the paper and the event chains of breaks are shown at the moment of occurring, i.e. before the web has reached the next camera. Thus the amount, availability, and usability of the information are at a high level. Deviations, deviation maps, or web-breaks from the web-break library can be display in the user interface. The films are displayed in a synchronized manner.

The user interface 21 shown in FIG. 9 is split into two displays using dual-display technology, with a defect map 100 being shown at the right-hand edge of the right-hand side display 83. A length of the web defined by the operator is shown in the defect, i.e. deviation map 100. The deviation map is imaged immediately before reeling, so that the map depicts the quality of the paper web manufactured on the paper machine. In the deviation map 100 the web travels downwards, representing the defined web, so that new defects, i.e. deviations appear in view at the upper edge of the deviation map 100. The deviations are marked on the map by symbols 101, which depict well the basic type and size of the deviation. If the deviation has a long duration, for example, as a coating streak, the symbol 101 on the deviation map 100 is scaled to correspond to its length. At any time, a search menu can be used to select only the desired deviations for display on the map, so that deviations that are inessential in terms of examination can be removed for the duration of the examination. The desired amount of the map can be rolled back, or it can be focussed on any point whatever in previous production. Focussing can take place, for example, based on time or the reeling-drum number. Defect groups can be zoomed from the map with a single mouse click, when the map enlarges around the selected point, for example, four times with each click. The precise data of the deviation are shown with a double click of the mouse. The deviations can be shown in the deviation display, which is at the same location as the break-analysis display 102. Once some deviation has been opened in the deviation display, an image of the deviation is ween in the deviation frame at the upper left-hand corner of the deviation display. Beneath the deviation display all the images in the event sequence showing the creation of the defect are shown beneath the deviation frame. Each image in the event sequence can examined separately. On the right-hand side of the defect map 100 is a trend display 104, which shows the distributions of the defects in the defect map 100 as trend curve in the machine direction. Beneath the defect map 100 is a profile display 108 of the defects in the defect map, from which the distribution of deviations in the cross direction can be seen.

In FIG. 9, there is a most-recent deviation display 110 at the upper edge of the display, at the left-hand side of the defect map in the right-hand display 83. The most recent deviation is shown automatically in this display. A deviation becomes the most recent deviation in the display, as soon as it has been detected. In the most-recent deviation display, the image is not compressed in any way and is shown in its natural size. If the image of the deviation will not fit into the most-recent deviation display 110 being used, the deviation will be reduced automatically in a suitable ratio. The reduction ratio is shown in an eye-catching colour, for example red. Showing the reduction ratio clearly is important, so that it will be easy for the operator to follow the process and assess the significance of the deviation. A priority is set for deviations, on the basis of which their appearance on the display is determined. If there are few deviations, the priority will not be needed, but when many deviations appear the priority will define the deviation to be displayed. In that case, the deviation with the highest priority will overtake a deviation equipped with a lower-level priority. Once a predefined delay has passed, the next deviation is displayed. The deviation to be displayed then can have a lower priority that the previous one.

In FIG. 9, breaks are shown in a break-analysis display 102 beneath the most-recent defect display 110 at the left-hand side of the deviation map 100 in the right-hand display. A break can be retrieved for examination in the break-analysis display either by a double click in the event sequence, or from a break list. A machine image in the same format as on the sequence display and images from four cameras open automatically in the display. The images of the cameras are selected in such a way that the upper frames show images from the cameras at which the break was first detected. In the lower frames in turn, images appear from the cameras in which the initial cause leading to the break was detected. Beneath the camera images is a bar, which represents the length of the film recorded from the cameras. By moving the button on the bar, the camera's images are moved backwards and forwards. The images are synchronized with each other in such a way that they show the same point on the web. The operator can select the desired cameras for the frames of the four-frame display by dragging and dropping them from the machine-image menu. The entire area of the four-frame display can be reserved for a single camera by clicking on the image of the camera (not shown). When examining a single-camera image, the camera's image-analysis disturbance trend will appear at the lower edge of the frame, which is the mathematical result of the sum of all the analyses, weighted with the importance of the detected disturbances.

FIG. 10 shows a situation, in which the break-analysis display 102 together with the paper-machine diagram 34 is enlarged to the size of nearly the entire right-hand display 83. When the break-analysis fills the right-hand display 83, the deviation map 100 and the most-recent defect display 110 are moved to the left-hand display 85.

In FIG. 11, a formation display 106 is shown beneath the most-recent deviation display 110 at the left-hand side of the defect map 100 in the right-hand display 83. The formation display 106 is in the same location as the break-analysis display (FIG. 9). The web formation is determined by imaging the web precisely, with illumination taking place as through-lighting by strobe lights. The formation display 106 is in its natural size and its scaling can be changes by using the zoom function. The web is viewed in its entirety by rolling the view over the web in the cross direction.

In FIG. 11, there is formation characteristic display 112 above the formation display 106, in which the formation characteristics calculated from the image area and the characteristics of the formation of the entire web are displayed. The characteristic displayed include the formation index, i.e. the total variation, the mean floc size, and skewness. Characteristics can also be shown are trends and formation profiles (not shown). In the profile display, the web is divided into 2 cm side bands in the cross direction, the formation characteristics being shown for each band.

In FIGS. 9 and 11, an alarm display 114 is located in the left-hand upper corner of the right-hand display 83. The alarm display shows the active and most recent alarms. A deviation counter display 116 is located beneath the alarm display 114 in the left-hand upper corner of the right-hand display 83. The deviation counter display 116 is used to show the number of deviations, by deviation class, in the reeling drum in production. Other values too, such as the reeling-drum number, the grade code, and the speed, can also be shown in connection with the deviation counter display. In addition, there are short-cut keys 118 at the upper edge of the right-hand display 83, by which most of the frames can be activated or removed.

At the lower edge of the left-hand display 85 shown in FIGS. 9-11, there are trend frames 120. Any of the numerical values whatever measured and calculated by the system can be freely selected as a trend to be shown in the trend frames. With the aid of an OPC link, process variables from the machine's automation system can also be retrieved to the trend frames for comparison. The variables calculated by the automation system are, for example, the change index of each camera, the location and stability of the edge of the web, the separation angle, the degree of dirtying of the couch squirt, the characteristics of the formation, defect trends and break statistics as a function of time. In place of the trend frames, it is also possible to show profile displays. The profile frames are in the same format as the trends. Profiles can be shown of numbers, from which a transverse distribution can be calculated, such as the various defects in the paper, or the characteristics of the formation. A time scale, y-axis, or other variables can be freely selected for each trend and profile frame. The time scale of the display can also be rolled, i.e. the trend/profile can be moved incrementally in time. The most recent period of time of a desired length can be selected for display, or the examination moved to a desired moment or reeling drum.

In the trend frames it is possible to show a colour map of deviations, in which the x direction is the cross direction of the paper and the y direction is time. Different colours are used to show the density of occurrence of defects as a function of time and cross direction, i.e. to see immediately a temporal disturbance, which is concentrated in a specific cross-direction location. The break statistic can be shown in the trend display. Statistics of the desired data of breaks can be made, which can be shown with the aid of bar diagrams or pie charts. Detailed break data for about two years' can be stored in the database.

In the break statistic, the breaks can be shown for a selected period of time, according to cause, break location, and cross-direction location. A reporting tool allows the displays to be edited in the manner desired by the operator. The breaks can also be examined through a break library, in which the breaks are registered according to their temporal order of arrival. The cause, location, and duration of a break can be seen directly from the break library, while clicking on a break opens the stored films on the break-analysis display for re-examination.

Repeating deviations can appear in a paper web, and can be caused by the most varied factors. Repeating deviations often appear at a specific frequency, so that frequency analysis is often used in the analysis of repeating deviations. In frequency analysis, the known machine-element lengths of the paper machine are utilized. If a repeating deviation is detected, its frequency is compared with the machine-element lengths. If a correlation is detected between the frequency and the machine-element lengths, a alarm appears on the alarm display directly with the name of the machine element. If a correlation is not detected between the frequency and the machine-element lengths, but the detected deviation repeats at a specific frequency, the web length of the repetition frequency is stated with the alarm. The alarm also states the type of deviation and allows the deviation to be seen as an image. At the same time, the repeating density of the deviation is given as a percentage of the maximum possible density. The operator can prevent a repeating deviation from being shown on the sequence display, nor do the notifications coming about it take up the time of the operator, once the operator has been informed about a repeating deviation.

The reel map shows the trim planned for the reeling drum and the deviation map superimposed on each other. Thus the deviation map of each reel being cut is shown. The trim can be shown continuously, or shown on request. The deviation map shown the trim according to the entire reeling drum or divided into reels. The reel map is suitable for use mainly on a slitter-winder, in which case the quality of the reels to be cut can be examined beforehand.

In addition to the analyses described above, the system includes special analyses available for all cameras. The analysis of the dirtying of the couch squirt is one of these. This analysis is performed in the server and implemented using specially developed image-analysis software. The analysis calculates continuously the surface area of the couch squirt and give an alarm, if the surface area exceeds the original surface area by a given percentage. The analysis is implemented using adaptive methods, which adapt to changing conditions and do not require tuning. The only measure required from the operator is to delimit the couch squirt from the images with the aid of the ROI area and to state the analysis to be implemented in the ROI area as being a couch-squirt analysis, give the alarm value, and name the couch squirt.

The special analyses also include the measurement and monitoring of the separation angle as well as the measurement of the location of the web edge, and the measurement and monitoring of the web width. Monitoring of the edge is implemented directly in the DSP processor and is calculated from each image. The operator can use the ROI analysis to select any camera whatever to monitor the edge and even several locations within a single camera. Each location must be given a name, for example, ‘separation angle middle roll front side’. In the ROI analysis, the vector of the edge location to be monitored is set, in which the direction should be selected in such a way that it emphasized the objective. If, for example, it is wished to monitor the edge in the width direction, the vector is set in the cross direction of the web and calibrated as location co-ordinates. If the edge of the web is monitored, for example, in the vertical direction of flutter, the vector is set to the vertical direction and vertical co-ordinates are calibrated. When measuring the separation angle, the vector is set to the separation area as close as possible to the separation point and the separation angle is calibrated as are the co-ordinates of the separation point. The system uses adaptive algorithms to calculate the location of the edge in the area of the set vector and converts it to the desired number with the aid of calibration. The number is the same as any other measurement value of the process and can give an alarm, be shown as a trend, and taken to external systems with the aid of the OPC. In a disturbance, for example, in a break, these variables can be taken to the correlation trend and the cause-effect relations of the different variables can be seen. From the location of the edge of the web, it is also possible to calculate the width of the web, provided that the location of the edge of the web is measured on both sides of the machine. The normal accuracy of the measurement of the location of the edge of the web is about 5 mm, but by focussing the camera more precisely to the edge of the delimited area, the accuracy can be increased up to 1 mm.

The software required in the system can be programmed on a .NET base, based on server architecture and a 1-Gb data-transfer network. The operating system in the servers can be Windows Server 2003. The servers are typically named, according to their purpose, as a camera server and a database server. The camera server primarily takes case of traffic to the analysis processors, performs the final classification of the events, stores and sends the event sequences and break films to the operation station. The database server contains all the configuration information and an SQL database for the events and paper defects.

When retrieving films or uncompressed images from the ring buffer, the operation of the buffer is never stopped, no image is lost, nor is there any humanly-detectable delay in the system. Communication with the server is taken care of by the communication processor and through the 1-Gb data-transfer network, preferably a LAN. The automatically detected deviations are sent in the form of classification results and an uncompressed image.

The image in digital form of each camera is sent to the quadruple circuit, where four cards are used to form from the camera's signals the combinations desired by the operator of quadruple images or images from a single camera. It is possible to program in the card two outputs, i.e. programmatically to select two different combinations. The outputs are standard-compliant video signals, which can be connected to any video monitor whatever for display.

By combining images, it is possible to construct quadruple displays from the desired cameras entirely freely. In principle, the image stream can be used to replace analog quadruple displays and take any view whatever over the network to any camera whatever, or several cameras to a combination display.

The examples presented above are only examples of embodiments for one skilled in the art. They in no way restrict the Claims presented.

1-25. (canceled)

26. Method for monitoring a rapidly-moving paper web,
method comprising steps of:
taking images of the rapidly-moving web with cameras at several consecutive positions, of the same cross-direction point of the web,
analysing the images at each position entirely automatically and in real time, this analysis including pattern recognition, in order to detect a deviating pattern in an image,
distinguishing deviations and determining their position data,
combining distinguished images automatically to belong to same event chains at the different positions in real time and using a selected criterion,
connecting each found deviation into an event chain using a selected criterion, on the basis of the position data of each deviation, and
showing the images of each event chain to the operator automatically using a selected criterion.

27. Method according to claim 26, wherein at least 50 images/s are taken of the paper web.

28. Method according to claim 26, wherein the level of the images taken is at least black-and-white VGA with a depth of 10 bits.

29. Method according to claims 26, wherein the images consist of pixels, which at their most precise correspond to an area of a maximum of 10*10 mm.

30. Method according to claims 26, wherein a distance of 10-400 mm of the paper web is imaged at one time.

31. Method according to claims 26, wherein the paper web moves 100-10000 m/min.

32. Method according to claims 26, wherein a calculating power of 0.05-10 teraflops corresponding to an image stream of 600 Mb/s, is used in the analysis of the images.

33. Method according to claims 26, wherein only the images, in which a deviation is detected, are stored permanently.

34. Method according to claims 26, wherein essentially all the images taken are stored momentarily in a buffer memory.

35. Method according to claim 26, wherein the selected criterion is based on the location of the deviations in the cross direction of the paper web.

36. Method according to claim 27, wherein the selected criterion is based on the pattern of the deviations.

37. System for monitoring a rapidly-moving paper web, which system includes:
cameras for taking images of the paper web in several consecutive positions at the same point in the cross-direction of the web,
a processing unit for analysing the images entirely automatically and in real time by the image-analysis method including pattern recognition, in order to distinguish each image containing a deviation and to determine the position data of the deviation, and to arrange the images distinguished taken in the different positions to be combined in the same event chain using a selected criterion,
an operation station for controlling the system,
a host unit for timing the imaging,
display means for showing automatically the images of each event chain to the operator,

38. System according to claim 37, wherein in the processing unit there is calculating power of 0.05-10 teraflops corresponding to an image stream of 600 Mb/s.

39. System according to claim 37, wherein for every one camera there is one image-analysis processor card.

40. System according to claim 37, wherein the cameras are arranged so send at least 50 images per second.

41. System according to claim 37, wherein the images taken are at least at a black-and-white VGA level.

42. System according to claim 37, wherein the system includes a buffer memory.

43. System according to claim 37, wherein that it includes permanent storage media.

44. System according to claims 37, wherein at least some of the cameras are matrix cameras.

45. System according to claims 37, in which the paper web is arranged to be illuminated using lighting elements, wherein at least some of the lighting elements are strobe-lighting elements.

46. System according to claim 37, wherein there is a fibre-optic cable between the cameras and processing unit.

47. System according to claims 37, wherein there is a data-transfer network between the processing unit and the operation station.

48. System according to claim 37, wherein in connection with at least one camera there is a camera processor, by means of which a set of measurement data relating to the environment of the camera is arranged to be sent to the processing unit.
